(19) United States
(12) Patent Application Publication
(10) Pub. No.: US 2023/0027971 A1
(43) Pub. Date: Jan. 26, 2023

(54) IMAGE-FORMING APPARATUS

(71) Applicant: SHARP KABUSHIKI KAISHA, Osaka (JP)

(72) Inventor: Naoki HASEGAWA, Osaka (JP)

(21) Appl. No.: 17/863,753

(22) Filed: Jul. 13, 2022

(30) Foreign Application Priority Data
Jul. 21, 2021 (JP) 2021-120808

(51) Int. Cl. B65H 9/04; B65H 1/04

(52) U.S. Cl. CPC B65H 9/04; B65H 1/04; B65H 2701/1131; B65H 2801/03; B65H 2551/21; B65H 2511/11; B65H 2511/12; B65H 2220/02

(57) ABSTRACT

There are a paper storage that stores paper on which an image is formed, a paper guide that is movably provided in the paper storage and restricts a position of the stored paper, a paper size acquirer that acquires a size of the paper stored in the paper storage, a size change determiner that determines, by using the acquired size of the paper, whether the paper stored in the paper storage was changed, a confirmation information selector that, when it is determined that the paper stored in the paper storage was changed, selects confirmation information requesting confirmation of a position of the paper guide in the paper storage in accordance with a difference in size between paper before and after the change, and a confirmation information notifier that notifies the selected confirmation information.

### BACKGROUND OF THE INVENTION

### Field of the Invention

The present disclosure relates to an image-forming apparatus and, in particular, to an image-forming apparatus that does not have the function to detect the size of paper stored in a paper feed tray when a user refills the paper feed tray with paper and to a paper guide confirmation method.

### Description of the Background Art

There are conventionally used image-forming apparatuses including one or more paper feed trays that may store multiple sizes of paper so as to print on paper in any one of the sizes.

One paper feed tray stores multiple pieces of paper of the same type and, when a printing process is performed, the paper is taken out from the paper feed tray one by one onto a paper conveyance path and conveyed to a printing site where a developing device and a photoreceptor drum are provided.

For example, the paper feed tray may store A4-size paper or A3-size paper, and a paper guide that comes into contact with the stored paper is provided to take out the paper in a proper posture in either case where A4-size paper is stored or A3-size paper is stored.

In order to detect no paper feed that is a state where no paper is taken out from the paper feed tray to a predetermined position in the paper conveyance path, some image-forming apparatuses include a sensor that detects the presence or absence of paper.

For example, an image-forming apparatus is known, which includes a plurality of paper feed cassettes and a paper sensor that detects the presence or absence of paper near a conveyance roller that conveys the paper from the paper feed cassette to a paper conveyance path, and when the paper sensor detects no paper and it is determined that no paper feed has occurred, a message corresponding to the cause of occurrence of no paper feed, such as “Please confirm the paper in the cassette”, “Please set the paper in the cassette again”, or “Please remove the paper”, is displayed so that the user may know the cause of occurrence of no paper feed and resolve no paper feed.

However, even when the message is displayed to prompt the user to confirm the paper in the cassette or set the paper in the cassette again in order to notify the user of the occurrence of no paper feed, the user may be uncertain which paper feed cassette to confirm, what to confirm about the paper, or how to set the paper in the cassette again.

Even when the user sets the paper in the paper feed cassette in the correct position again or removes the paper having a trouble based on the displayed message, the paper guide may be incorrectly in contact with the paper.

When the paper guide is not correctly in contact with the paper, it is difficult to properly convey the paper to the paper conveyance path even after the printing is resumed, and a similar paper feed jam may occur again.
When the user does not recognize that the cause of occurrence of the paper feed jam is improper adjustment of the paper guide, a similar paper feed jam occurs over and over again, which may result in the waste of a large number of pieces of paper.

When the user changes the size of the paper stored in the paper feed tray, the user needs to move the position of the paper guide so as to match the size of the paper after the change so that the paper may be properly taken out from the paper feed tray.

The user may fail to move the position of the paper guide or may be unaware of moving the position of the paper guide itself, and for example when the paper stored in the paper feed tray is changed from a large paper size (e.g., A3 size) to a small paper size (e.g., A4 size) and the user fails to move the position of the paper guide to be correctly in contact with the small paper after the change, a paper feed jam may occur.

In image-forming apparatuses that, in order to reduce the cost of the image-forming apparatuses, do not have the function to detect the size of the paper stored in the paper feed tray or that do not automatically detect the position of the paper guide, the user needs to perform the operation to adjust the position of the paper guide by himself/herself, but incorrect adjustment of the paper guide increases the possibility of occurrence of a paper feed jam.

The present disclosure has been made in consideration of the above circumstances and has an object to provide an image-forming apparatus that may reduce the possibility of occurrence of a paper feed jam due to improper adjustment of a paper guide included in a paper feed tray.

### SUMMARY OF THE INVENTION

The present disclosure provides an image-forming apparatus including a paper storage that stores paper on which an image is formed, a paper guide that is movably provided in the paper storage and restricts a position of the stored paper, a paper size acquirer that acquires a size of the paper stored in the paper storage, a size change determiner that determines, by using the acquired size of the paper, whether the paper stored in the paper storage was changed, a confirmation information selector that, when it is determined that the paper stored in the paper storage was changed, selects confirmation information requesting confirmation of a position of the paper guide in the paper storage in accordance with a difference in size between paper before and after the change, and a confirmation information notifier that notifies the selected confirmation information.

An operation acceptor is further included, with which a type of the stored paper is input, wherein the paper size acquirer acquires a size of paper previously associated with the type based on the input type of the paper.

A memory is further included, which stores previous paper size information that is a size of first paper stored in the paper storage before the paper was changed, wherein the paper size acquirer acquires current paper size information that is a size of second paper after the paper stored in the paper storage was changed, the size change determiner compares the previous paper size information with the current paper size information to determine whether the size of the second paper is different from the size of the first paper, and when it is determined that the size of the second paper is different from the size of the first paper, the confirmation information selector selects the confirmation information.

The size of the paper acquired by the paper size acquirer includes a length of the paper in a direction parallel to a conveyance direction to take out the paper stored in the paper storage and a width in a direction perpendicular to the conveyance direction, the paper guide includes a rear end guide that comes into contact with one side at a rear end of the stored paper to restrict the position of the stored paper and is movable in the conveyance direction, and a width guide that comes into contact with one side of the stored paper in the direction perpendicular to the conveyance direction to restrict the position of the stored paper and is movable in the direction perpendicular to the conveyance direction, and the confirmation information selector selects confirmation information requesting confirmation of one or both of positions of the rear end guide and the width guide based on a difference in the length between paper before and after the change and a difference in the width between paper before and after the change.

When the length of the paper after the change stored in the paper storage is smaller than the length of the paper before the change stored in the paper storage, the confirmation information selector selects confirmation information requesting confirmation of the position of the rear end guide.

When the width of the paper after the change stored in the paper storage is smaller than the width of the paper before the change stored in the paper storage, the confirmation information selector selects confirmation information requesting confirmation of the position of the width guide.

When the length of the paper after the change stored in the paper storage is smaller than the length of the paper before the change stored in the paper storage and the width of the paper after the change stored in the paper storage is smaller than the width of the paper before the change stored in the paper storage, the confirmation information selector selects confirmation information requesting confirmation of the positions of the rear end guide and the width guide.

A display is further included, wherein the confirmation information notifier displays the selected confirmation information on the display to notify the user.

The present disclosure provides a paper guide confirmation method for an image-forming apparatus, and the paper guide confirmation method includes acquiring, when a type of paper stored in a paper feed tray, which stores paper, is input, a size of the paper previously associated with the input type of the paper, determining, by using the acquired size of the paper, whether the paper stored in the paper feed tray was changed, selecting, when it is determined that the paper stored in the paper feed tray was changed, confirmation information requesting confirmation of a position of a paper guide movably provided in the paper feed tray in accordance with a difference in size between paper before and after the change, and notifying the selected confirmation information to a user.

According to the present disclosure, when the paper stored in the paper storage is changed, the confirmation information requesting confirmation of the position of the paper guide is selected in accordance with the difference in size between paper before and after the change, and the selected confirmation information is notified, and thus it is possible to reduce the possibility of occurrence of a paper feed jam due to improper adjustment of the paper guide included in the paper storage.

### BRIEF DESCRIPTION OF THE DRAWINGS

FIG. 1 is a configuration block diagram of an image-forming apparatus according to an embodiment of the present disclosure.

FIG. 2 is a table illustrating information (standard paper information) stored in a memory of the image-forming apparatus according to an embodiment of the present disclosure.

FIG. 3 is a table illustrating information (confirmation information selection condition) stored in the memory of the image-forming apparatus according to an embodiment of the present disclosure.

FIG. 4 is a table illustrating information (tray confirmation information) stored in the memory of the image-forming apparatus according to an embodiment of the present disclosure.

FIG. 5 is a table illustrating information (tray paper information) stored in the memory of the image-forming apparatus according to an embodiment of the present disclosure.

FIG. 6A is an explanatory diagram illustrating a schematic configuration of a paper feed tray and a paper guide of the image-forming apparatus according to an embodiment of the present disclosure.

FIG. 6B is an explanatory diagram illustrating movement positions of the paper guides when paper is stored in the paper feed tray of the image-forming apparatus according to an embodiment of the present disclosure.

FIG. 6C is an explanatory diagram illustrating movement positions of the paper guides when the paper is stored in the paper feed tray of the image-forming apparatus according to an embodiment of the present disclosure.

FIG. 7 is an explanatory diagram illustrating the state where the paper guide of the paper feed tray has not been adjusted (improper adjustment of a rear end guide) according to an embodiment of the present disclosure.

FIG. 8 is an explanatory diagram illustrating the state where the paper guides in the paper feed tray have not been adjusted (improper adjustment of width guides) according to an embodiment of the present disclosure.

FIG. 9 is an explanatory diagram illustrating the state where the paper guides in the paper feed tray have not been adjusted (improper adjustment of the rear end guide and the width guides) according to an embodiment of the present disclosure.

FIG. 10 is an explanatory diagram illustrating a setting input screen when the paper stored in the paper feed tray is changed according to an embodiment of the present disclosure.

FIG. 11 is an explanatory diagram illustrating a display screen requesting the confirmation of the paper guide, which is presented on a display when the paper stored in the paper feed tray is changed according to an embodiment of the present disclosure.

FIG. 12 is an explanatory diagram illustrating a display screen requesting the confirmation of the paper guides, which is presented on the display when the paper stored in the paper feed tray is changed according to an embodiment of the present disclosure.

FIG. 13 is an explanatory diagram illustrating a display screen requesting the confirmation of the paper guides, which is presented on the display when the paper stored in the paper feed tray is changed according to an embodiment of the present disclosure.

FIG. 14 is an explanatory diagram illustrating setting input and a display screen when the paper in the paper feed tray is changed according to an embodiment of the present disclosure.

FIG. 15 is an explanatory diagram illustrating setting input and a display screen when the paper in the paper feed tray is changed according to an embodiment of the present disclosure.

FIG. 16 is an explanatory diagram illustrating setting input and a display screen when the paper in the paper feed tray is changed according to an embodiment of the present disclosure.

FIG. 17 is a flowchart illustrating a paper guide confirmation request process when the paper stored in the paper feed tray is changed according to an embodiment of the present disclosure.

FIG. 18 is a flowchart illustrating selection of the paper feed tray and a setting input process of the type of stored paper according to an embodiment of the present disclosure.

FIG. 19 is a flowchart illustrating a selection determination process for the confirmation information on the paper guide according to an embodiment of the present disclosure.

### DESCRIPTION OF THE PREFERRED EMBODIMENTS

An embodiment of the present disclosure will be described below with reference to the drawings. The description of the embodiment below does not limit the present disclosure.

An image-forming apparatus (hereinafter also referred to as “multifunction peripheral (MFP)”) is an apparatus that processes image data and is, for example, an electronic device having a duplication (copying) function, a printing function, a document reading (scanning) function, a document editing function, a document storage function, a document transmission (fax) function, a communication function, etc.

The image-forming apparatus includes a storage device that stores multiple pieces of paper, on which image data is printed, to take out paper having a predetermined size, on which image data is printed, one by one from the storage device, convey the paper to a printing site, and print the image data on the conveyed paper. The storage device corresponds to a paper storage described below.

Configuration of Image-Forming Apparatus

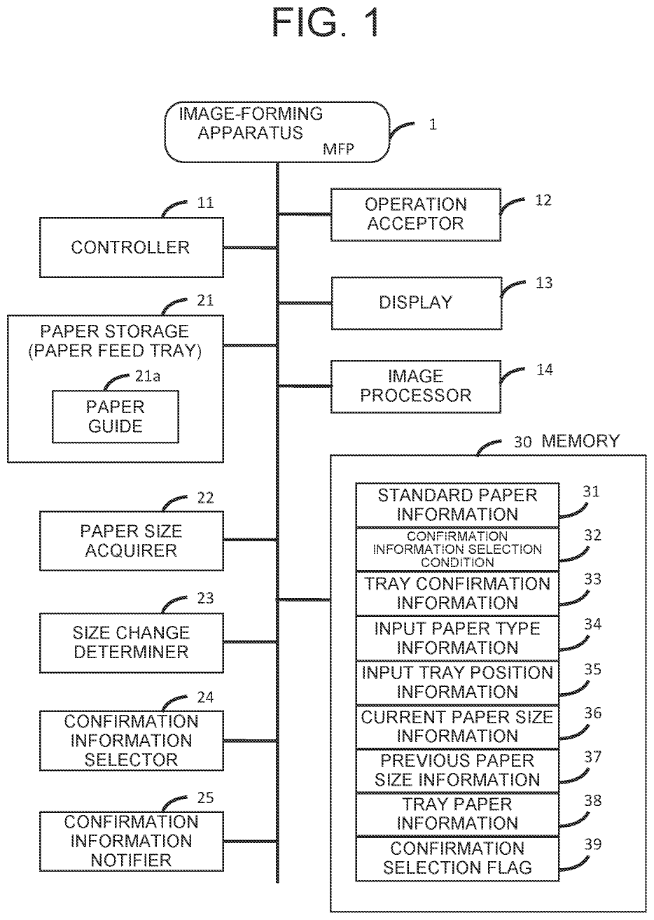

FIG. 1 is a configuration block diagram of an image-forming apparatus according to an embodiment of the present disclosure.
An image-forming apparatus (MFP) 1 is a multifunctional peripheral having multiple functions as described above but has at least a printing function according to the embodiment below.

In FIG. 1, the image-forming apparatus (MFP) 1 primarily includes a controller 11, an operation acceptor 12, a display 13, an image processor 14, a paper storage 21, a paper size acquirer 22, a size change determiner 23, a confirmation information selector 24, a confirmation information notifier 25, and a memory 30.

The controller 11 is a part that controls an operation of each component, such as the operation acceptor and the image processor, and is primarily implemented by a microcomputer including a CPU, a ROM, a RAM, an I/O controller, a timer, etc.

The CPU organically operates various types of hardware based on control programs previously stored in the ROM, etc., to execute an image processing functions, etc., according to the present disclosure.
The paper size acquirer 22, the size change determiner 23, and the confirmation information selector 24 are functional blocks whose functions are executed by the CPU of the controller 11 based on the control programs stored in the ROM, etc.

The operation acceptor 12 is a part with which a user of the image-forming apparatus inputs information and is an input device for performing a predetermined input operation to operate the image-forming apparatus. For example, the operation acceptor 12 is a part for inputting information such as characters and selecting and inputting a function, and a keyboard, a mouse, a touch panel, or the like, is used.

The keys operated by the user include an operation start key, a function selection key, a setting key, etc.
For example, the user performs an operation to provide an input on a touch panel or a start key for a reading operation to execute a print item setting function, a print function, etc.
According to the present disclosure, the user uses the operation acceptor 12 to input the type of paper stored in the paper storage 21, etc. In particular, when the print paper stored in the paper storage 21 is changed, the operation acceptor 12 is used to set and input the type of paper after the change.

The display 13 is a part that displays information and displays the information needed to execute each function, a result of execution of a function, and the like, in order to notify the user. For example, an LCD, an organic EL display, or the like, is used and, when a touch panel is used as the operation acceptor 12, the display 13 and the touch panel are provided in a superimposed manner.

For example, the display 13 uses characters, symbols, graphics, images, icons, animations, moving images, and the like, to display the information needed to set the setting items used for printing, and the like, of the image-forming apparatus and to execute the printing function, and the like, an operation screen of a selected function, a print item setting operation screen, etc.
According to the present disclosure, as described below, the display 13 presents a setting input screen for a paper change and a confirmation screen of the paper guide for a paper change.

The image processor 14 is a part that executes an image forming function, which is a primary function of the image-forming apparatus, and primarily includes an image inputter, an image former, and an image outputter.

Primarily, the image inputter is a part that inputs predetermined image data, the image former is a part that converts the input image data into information that may be printed, and the like, and the image outputter is a part that outputs the formed print information, and the like, onto print paper, etc.

The image inputter is a part that inputs the image data on a document describing an image, character, graphic, and the like, and is for example a part that reads the document placed on a document table, etc.

A scanner (reading device) that reads the document describing information is used as the image inputter.
In order to read the document, the image-forming apparatus includes a document placement table (document table) on which the document is placed and a document cover that presses the document.
The image-forming apparatus may include an automatic document feeder (ADF) that has a plurality of documents placed thereon and automatically feeds and reads the documents one by one.
In this case, the scanner reads the document describing an image, and the like, and stores the image data on the document in the memory 30.

There are various methods for inputting image information. For example, the image information transmitted from an information processing apparatus TE such as a personal computer or a mobile terminal owned by the user or a server may be input via a network 3.

The image inputter corresponds to an interface connecting an external storage medium such as a USB memory.
An electronic data file of the image information to be input, and the like, may be stored in an external storage medium such as a USB memory, the USB memory, or the like, may be coupled to an input interface such as a USB terminal, a predetermined input operation may be performed with the operation acceptor 12 to read the desired electronic data file stored in the USB memory, or the like, and the electronic data file may be stored as input image data in the memory 30.

For example, to print the input image data on a recording medium, the image former typically performs the steps for charging, exposure, development, transfer, cleaning, static elimination, and fusing in a continuous manner to form the input image data on the recording medium. During the developing step, the toner is supplied from a toner cartridge to a developing device, and an electrostatic latent image formed on a surface of a charged photoreceptor drum is developed to form a toner image corresponding to the electrostatic latent image. The toner image formed on the surface of the photoreceptor drum is transferred onto a recording medium by a transfer device and then heated by a fusing device to be fused to the recording medium.

The image former converts the input image data into information in a transferable and displayable form.

The image outputter is a part that outputs the formed input image data, corresponds to, for example, a printer that prints information such as the input image data, and prints the input image data on the read document on predetermined print paper (paper medium) taken out from the paper storage 21.

The output of the input image data includes not only printing but also storage of the input image data on the scanned document, fax transmission of the input image data on the scanned document, etc.
For example, the image output corresponds to storage of the input image data on the read document in an external storage medium such as USB memory and transmission of the input image data to another information processing apparatus or a server via a network such as the Internet.

The paper storage 21 is a part that stores the paper on which an image is formed and corresponds to a storage device that stores paper (print medium) on which the image data is printed.

To print the image data, paper is taken out from the storage device one by one and conveyed to the printing site where the developing device, and the like, are provided, and the image data is printed on the paper.
The storage device includes the one or more paper storages 21, and the one paper storage 21 stores multiple pieces of paper.
The storage device also includes a manual feed tray where the user places one or more pieces of paper.
The paper storage 21 is hereinafter also referred to as a paper feed tray.

The one paper storage (paper feed tray) 21 may store paper in multiple types of sizes and typically stores multiple pieces of paper of one identical type.

The paper storage (paper feed tray) 21 includes a paper guide 21a for proper take-out to a paper conveyance path.
The paper guide 21a is a plate-like member that is movably provided in the paper storage (paper feed tray) 21 and restricts the position of the stored paper.
The stored paper is typically rectangular, and the paper guide 21a comes into contact with a short side and a long side of the rectangular paper to restrict the position of the stored paper.
The paper guide 21a is mounted in a movable form at a predetermined position in a paper storage area of the paper feed tray 21 to allow the storage of paper in multiple types of sizes.

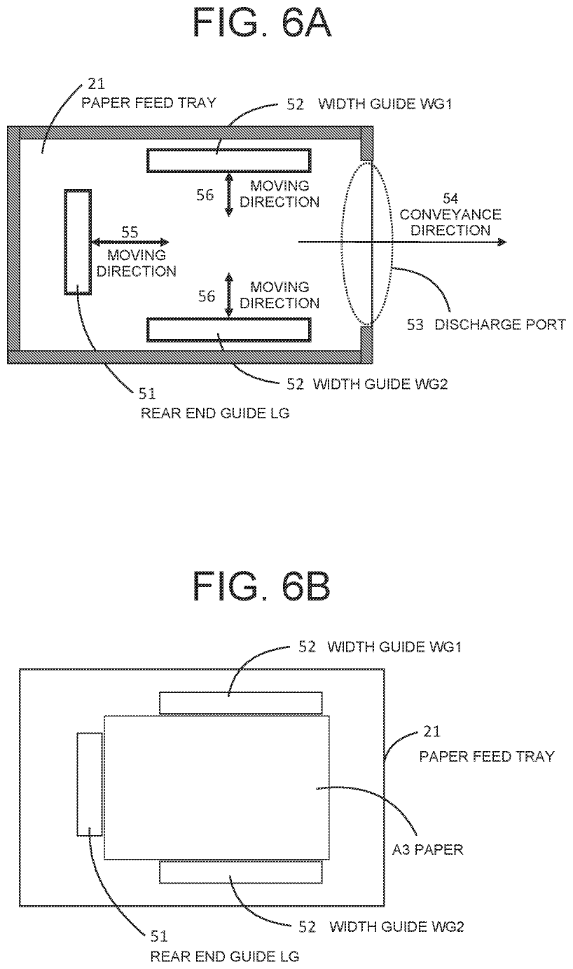

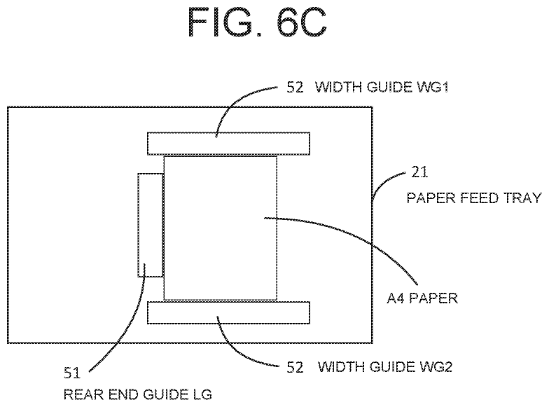

FIG. 6A is an explanatory diagram illustrating a schematic configuration of the paper feed tray and the paper guide of the image-forming apparatus according to an embodiment.

The paper feed tray 21 includes the paper guide 21a and, as illustrated in FIG. 6A, the paper guide 21a includes, for example, one rear end guide 51 (LG) and two width guides 52 (WG1 and WG2).
The paper stored in the paper feed tray 21 is stored in the area whose three sides are surrounded by the paper guide 21a, taken out by a conveyance roller (not illustrated) toward a discharge port 53 of the paper feed tray 21 in a conveyance direction 54 illustrated, and discharged through the discharge port 53. The conveyance direction 54 is a direction in which the paper stored in the paper feed tray 21 is taken out.

The rear end guide 51 is mounted at a position in the opposite direction of the discharge port 53, through which the paper is taken out from the paper feed tray 21, and is movable in a moving direction 55 illustrated.

The moving direction 55 is the same direction as the conveyance direction 54 described above.
The rear end guide 51 is a member that comes into contact with one side at the rear end of the paper stored in the paper feed tray 21 to restrict the position of the stored paper. When the paper is stored in the paper feed tray 21, the user performs the operation to move the rear end guide 51 to come into contact with one side at the rear end of the stored paper, thereby restricting the position of the rear end of the stored paper.

The width guide 52 is mounted to be movable in a moving direction 56 illustrated, which is a direction perpendicular to the conveyance direction 54 of the paper, which is taken out through the discharge port 53.

The width guide 52 is a member that comes into contact with one side of the stored paper in the direction perpendicular to the conveyance direction 54 to restrict the position of the stored paper.
When the paper is stored in the paper feed tray 21, the user moves the two width guides 52 in the lateral direction perpendicular to the conveyance direction 54 of the paper, which is taken out through the discharge port 53, to come into contact with one side of the stored paper and restrict the lateral position of the stored paper.

FIGS. 6B and 6C are explanatory diagrams illustrating movement positions of the paper guides when the paper is stored in the paper feed tray according to an embodiment.

FIG. 6B illustrates the movement positions of the paper guides when the paper (A3 paper) whose paper size is an A3 size is stored in the paper feed tray.
Here, the A3 paper is stored in such a state that the A3 paper elongates in a horizontal direction of the paper surface, the rear end guide 51 is moved to come into contact with the left short side of the A3 paper, the two width guides 52 are moved to come into contact with the upper long side and the lower long side of the A3 paper, and the storage position of the A3 paper is restricted.

FIG. 6C illustrates the movement positions of the paper guides when the paper (A4 paper) whose paper size is an A4 size is stored in the paper feed tray.

Here, the A4 paper is stored in such a state that the A4 paper elongates in a vertical direction of the paper surface, the rear end guide 51 is moved to come into contact with the left long side of the A4 paper, the two width guides 52 are moved to come into contact with the upper short side and the lower short side of the A3 paper, and the storage position of the A4 paper is restricted.

The positions of the paper guides in FIGS. 6B and 6C are proper adjustment positions, where the rear end guide 51 and the width guides 52 are in contact with the stored paper so that the stored paper may be restricted so as to hardly move.

When the paper guide is adjusted at such a position, the stored paper is properly taken out through the discharge port 53 of the paper feed tray 21, and thus paper feed jams are unlikely to occur.

The image-forming apparatus includes a storage box to which the one or more paper storages 21 are attached, and after the user stores the paper in the paper storage 21, the paper storage 21 is attached to the storage box.

To refill the paper storage 21 with paper when the paper stored therein runs out, the paper storage 21 is pulled out from the storage box, the paper is refilled in the paper storage 21, and then the paper storage 21 is put back in the storage box.
Alternatively, in the open-close type paper storage 21 that is attached to the storage box so as to open and close, the operation is performed to open the paper storage 21 from the storage box to supply the paper, and then the operation is performed to close the paper storage 21.

When the type of paper stored in the paper storage 21 is changed, especially the size of the previously stored paper is changed to the size of the newly stored paper, the user needs to move the rear end guide 51 and the width guides 52 of the paper guide 21a so as to come into contact with the new paper after refilling the paper storage 21 with the new paper.

Although the user needs to perform the operation to move the paper guide 21a, there is a possibility of occurrence of improper adjustment of the paper guide 21a by the user, such as the improper operation of the paper guide 21a or the failure to move the paper guide 21a.

The improper operation or the failure to move the paper guide 21a may cause the paper to be improperly taken out, and the improper adjustment of the paper guide 21a causes a paper feed jam.

Therefore, according to the present disclosure, when the stored paper is changed, which requires the operation to move the paper guide 21a, the user is notified of the confirmation information requesting the adjustment of the paper guide 21a, which prevents the improper adjustment of the paper guide 21a and reduces the possibility of occurrence of a paper feed jam.

In particular, the user is notified which of the rear end guide 51 and the width guides 52 among the paper guide 21a is to be confirmed depending on the relation of the size between the paper before and after the change.
Alternatively, the user is notified that both the rear end guide 51 and the width guides 52 are to be confirmed.

It is assumed that the image-forming apparatus according to the present disclosure does not have the function to automatically detect the size of the paper stored in the paper feed tray, the function to automatically detect the position of the paper guide 21a, or the function to automatically move the paper guide 21a.

The paper size acquirer 22 is a part that acquires the size of the paper stored in the paper storage 21.

Here, the size of the paper acquired by the paper size acquirer 22 includes a length L of the paper in a direction parallel to the conveyance direction 54 in which the paper stored in the paper storage 21 is taken out and a width W in a direction perpendicular to the conveyance direction 54.
Typically, when the stored paper is rectangular, the size refers to the length (primarily the long side) and the width (primarily the short side) of the rectangular paper.

As there is no function to automatically acquire the size of the paper stored in the paper feed tray according to the present disclosure, the person in charge of the management of the image-forming apparatus or the user who stored the paper uses the operation acceptor 12 to input the size of the stored paper.

As it is difficult for the user or the like to directly input the size of the stored paper, the user or the like inputs the type of stored paper, as in conventional image-forming apparatuses.
In the case of standard paper, information such as A3 or A4 is input as the type of paper.
The input type of paper is stored as input paper type information 34 described below.

Then, based on the input type of paper, the paper size acquirer 22 acquires the size of the paper that is previously associated with the type and set and stored.

It is considered that typically the paper used as print paper is often standard paper whose size is previously standardized, and therefore for example standard paper information 31, described below, which associates the type of standard paper with its size (width and length) is previously stored in the memory 30, and the standard paper information 31 is used to acquire the size of the stored paper.

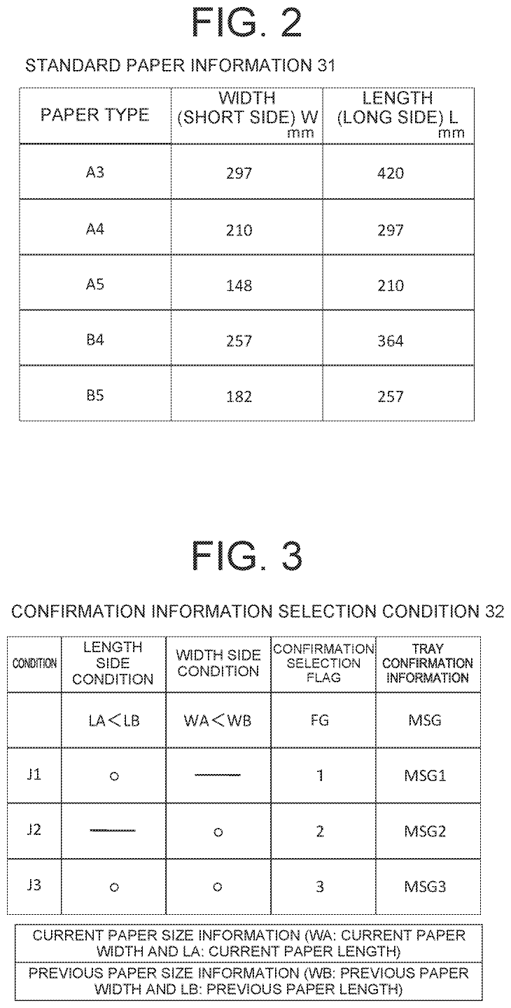

FIG. 2 is a table illustrating the standard paper information stored in the memory of the image-forming apparatus according to an embodiment. The standard paper information 31 in FIG. 2 stores the information in which the type of standard paper (paper type) is associated with its size (the width W and the length L).

In the standard paper information 31, for example, “A4” of the standard paper is set as the type of paper and the width (210 mm) and the length (297 mm) are set and stored in association with “A4”.

For example, when the standard paper having an A4 size is stored and “A4” is input by the user as the type of paper, the paper size acquirer 22 uses the standard paper information 31 to acquire the width (210 mm) and the length (297 mm) associated with “A4” as the size of the stored paper.

The input paper type and the acquired width and length are acquired as current paper size information 36 described below and stored in the memory 30.

The current paper size information 36 is the size of the paper (also referred to as second paper) after the paper stored in the paper storage 21 is changed.
When the size of the paper stored is unknown, the user may use the operation acceptor 12 to directly input the size of the stored paper.

The size change determiner 23 is a part that determines, by using the size of the paper acquired by the paper size acquirer 22, the size of the paper stored in the paper feed tray was changed.

Here, instead of directly measuring the size of the stored paper, the current paper size information 36 acquired by the paper size acquirer 22 described above is compared with previous paper size information 37 stored in the memory 30 to determine whether the size of the paper after the change is different from the size of the paper before the change.

The previous paper size information 37 is the size of the paper (also referred to as first paper) stored in the paper storage 21 before the paper size acquirer 22 acquires the current paper size information 36, that is, before the paper is changed.

The previous paper size information 37 is also the information including the paper type and the width and length of the paper.
Specifically, when the type of paper stored in the paper feed tray is not changed and the same type of paper is continuously stored, the information on the size of the stored paper is stored as the previous paper size information 37.

As described above, when the user inputs the type of paper, the paper size acquirer 22 uses the input type of paper to acquire the current paper size information 36, and when the acquired current paper size information 36 matches the previous paper size information 37, it is determined that the size of the stored paper was not changed.

Conversely, when the user inputs the type of paper and thus the newly acquired current paper size information 36 does not match the previous paper size information 37, it is determined that the size of the stored paper was changed.

As described below, to compare the current paper size information 36 with the previous paper size information 37, the widths thereof are compared to each other, and the lengths thereof are compared to each other. For example, when the width (WA) in the current paper size information 36 is smaller than the width (WB) in the previous paper size information 37, it is determined that the size of the stored paper was changed, and in this case, it is understood that paper having a smaller width than that of the previously stored paper is stored in the paper feed tray.

When the length (LA) in the current paper size information 36 is smaller than the length (LB) in the previous paper size information 37, it is determined that the size of the stored paper was changed and, in this case, it is understood that paper having a smaller length than that of the previously stored paper is stored in the paper feed tray.

Alternatively, when the width (WA) in the current paper size information 36 is smaller than the width (WB) in the previous paper size information 37 (WA<WB) and the length (LA) in the current paper size information 36 is smaller than the length (LB) in the previous paper size information 37 (LA<LB), it is determined that the size of the stored paper was changed and, in this case, it is understood that paper having a smaller width and length than those of the previously stored paper is stored in the paper feed tray.

When the size of the stored paper is changed, the user needs to perform the operation to change the position of the paper guide, and therefore in order to request the user to confirm that the position change operation was performed, the result of determination as to whether the size of the stored paper was changed is used to select the confirmation information for the paper feed tray to be notified to the user.

The confirmation information selector 24 is a part that, when the size change determiner 23 described above determines that the paper stored in the paper storage 21 was changed, selects the confirmation information requesting the confirmation of the position of the paper guide in the paper storage 21 in accordance with a difference in size between the paper before and after the change.

That is, when it is determined that the size of the second paper described above is different from the size of the first paper, the confirmation information selector 24 selects the confirmation information.
When the size of the stored paper is changed, the size includes the width and length of the paper, and therefore either the width or length or both the width and length are changed.

According to the present disclosure, when the size of the stored paper is changed, the user is notified of the confirmation information for the paper feed tray in order to prompt the user to confirm the position of the paper guide of the paper feed tray or in order to remind the user of the failure to move the paper guide for the purpose of preventing improper adjustment of the paper guide, such as the failure to move the rear end guide.

When the user is notified of the confirmation information for the paper feed tray, it is preferable to notify the information as to which one of the paper guides (the rear end guide and the width guides) of the paper feed tray is to be confirmed or adjusted (moved) so that the user may perform a confirmation work promptly.

Therefore, it is checked which of the width and the length was changed and, based on a check result, the content of the confirmation information for the paper feed tray to be notified to the user is selected.

In particular, as described below, the confirmation information selector 24 selects the confirmation information requesting the confirmation of one or both of the positions of the rear end guide and the width guides based on a difference in length between the paper before and after the change and a difference in width between the paper before and after the change.

Although details are described below, for example, when the length of the paper after the change stored in the paper storage 21 is smaller than the length of the paper before the change stored in the paper storage 21, the confirmation information selector 24 selects the confirmation information requesting the confirmation of the position of the rear end guide.

When the width of the paper after the change in the paper storage 21 is smaller than the width of the paper before the change stored in the paper storage 21, the confirmation information selector 24 selects the confirmation information requesting the confirmation of the positions of the width guides.

When the length of the paper after the change stored in the paper storage 21 is smaller than the length of the paper before the change stored in the paper storage 21 and the width of the paper after the change stored in the paper storage 21 is smaller than the width of the paper before the change stored in the paper storage 21, the confirmation information selector 24 selects the confirmation information requesting the confirmation of the positions of the rear end guide and the width guides.

For example, a confirmation information selection condition 32 described below is used to select the confirmation information for the paper feed tray.

FIG. 3 is a table illustrating the confirmation information selection condition stored in the memory of the image-forming apparatus according to an embodiment.
The confirmation information selection condition 32 in FIG. 3 is information in which a length side condition, a width side condition, a confirmation selection flag, and tray confirmation information are stored in association with each other.
The content of the confirmation information for the paper feed tray to be notified to the user is selected depending on whether these two conditions (the length side condition and the width side condition) are satisfied.

The length side condition is the comparison between the current paper length (LA) in the current paper size information and the previous paper length (LB) in the previous paper size information and, when LA<LB, the length side condition is satisfied.

That is, the length side condition is satisfied when the length (LA) after the change is shorter than the length (LB) before the change.
The width side condition is the comparison between the current paper width (WA) in the current paper size information and the previous paper width (WB) in the previous paper size information and, when WA<WB, the width side condition is satisfied. That is, the width side condition is satisfied when the width (WA) after the change is shorter than the width (WB) before the change.

The confirmation selection flag (FG) is information used to select the tray confirmation information and used by a program that executes a flowchart described below. Here, when any of three conditions (J1, J2, and J3) is satisfied, the confirmation selection flag (FG) is set to 1, 2, or 3 corresponding to the condition (J1, J2, or J3).

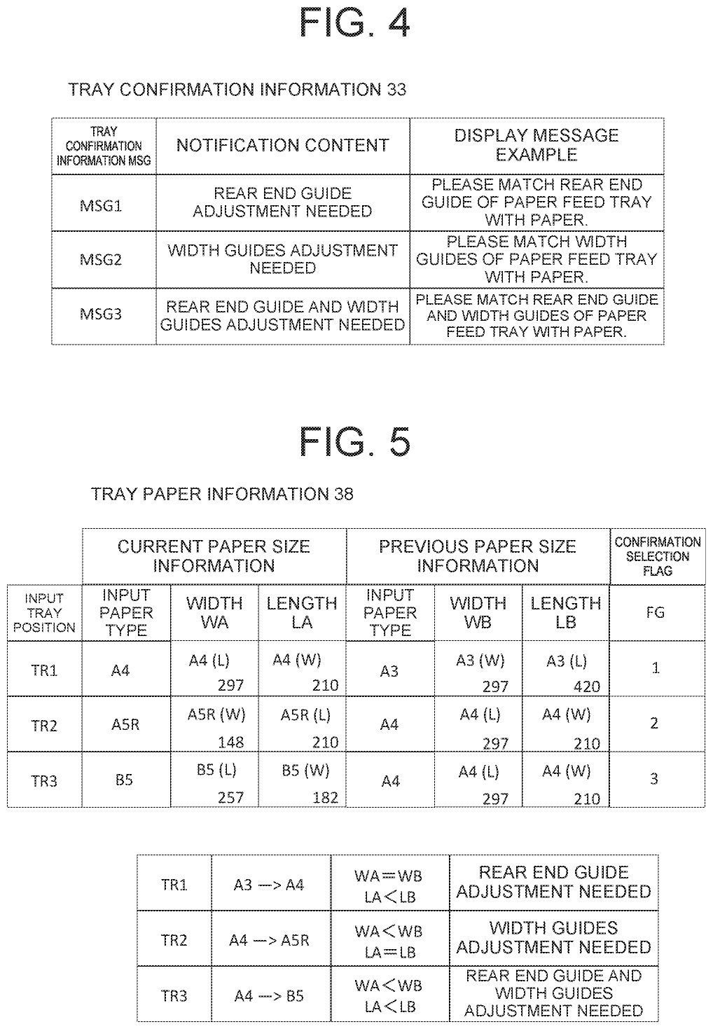

The tray confirmation information (MSG) is information that sets the content of the message to be notified to the user, and the detailed content of the tray confirmation information is illustrated in FIG. 4 below. Here, when any of the three conditions (J1, J2, and J3) is satisfied, the tray confirmation information (MSG) is set to MSG1, MSG2, or MSG3 corresponding to the condition (J1, J2, or J3).

The three conditions (J1, J2, and J3) are illustrated in the confirmation information selection condition 32 in FIG. 3, and the length side condition and the width side condition are used to determine whether each of the conditions is satisfied.

The confirmation selection flag (FG) and the tray confirmation information (MSG) are determined depending on whether one or both of the length side condition and the width side condition are satisfied.

For example, the condition J1 means that, when only the length side condition (LA<LB) is satisfied and the width side condition (WA<WB) is not satisfied, the confirmation selection flag (FG) is set to 1 and the tray confirmation information (MSG) is set to MSG1.

In this case, as the length (LA) after the change is shorter than the length (LB) before the change due to the change to the stored paper, the message is selected to remind that, among the paper guides, the rear end guide needs to be adjusted, as described below.

The condition J2 means that, when only the width side condition (WA<WB) is satisfied and the length side condition (LA<LB) is not satisfied, the confirmation selection flag (FG) is set to 2 and the tray confirmation information (MSG) is set to MSG2.

In this case, as the width (WA) after the change is shorter than the length (WB) before the change due to the change to the stored paper, the message is selected to remind that, among the paper guides, the width guides need to be adjusted, as described below.

The condition J3 means that, when the length side condition (LA<LB) and the width side condition (WA<WB) are satisfied, the confirmation selection flag (FG) is set to 3 and the tray confirmation information (MSG) is set to MSG3.

In this case, as the length (LA) after the change is shorter than the length (LB) before the change and the width (WA) after the change is shorter than the length (WB) before the change due to the change to the stored paper, the message is selected to remind that both of the paper guides, i.e., the rear end guide and the width guides need to be adjusted, as described below.

The confirmation information notifier 25 is a part that notifies the confirmation information (tray confirmation information) for the paper feed tray selected by the confirmation information selector 24.

The confirmation information (tray confirmation information) for the paper feed tray is notified to the person in charge of the management of the image-forming apparatus or the user.
The confirmation information notifier 25 displays the selected tray confirmation information for example in the form of the message using character information on the display 13 to notify the user, etc.
The tray confirmation information is displayed as a message, and thus it is possible to notify the user, and the like, that the paper guide of the paper feed tray needs to be adjusted.

Notification of the tray confirmation information does not need to be limited to message display, and other notification methods for notifying the tray confirmation information to the user may be used.

For example, when the image-forming apparatus includes a speaker, the user may be notified of the content of the tray confirmation information by voice.
Alternatively, the tray confirmation information may be displayed by using images, graphics, moving images, animation, and the like, allowing the user to understand the content of the tray confirmation information.
The tray confirmation information may also be transmitted to a mobile terminal owned by the person in charge of the management of the image-forming apparatus or the user.

The tray confirmation information may be previously stored in the memory 30.

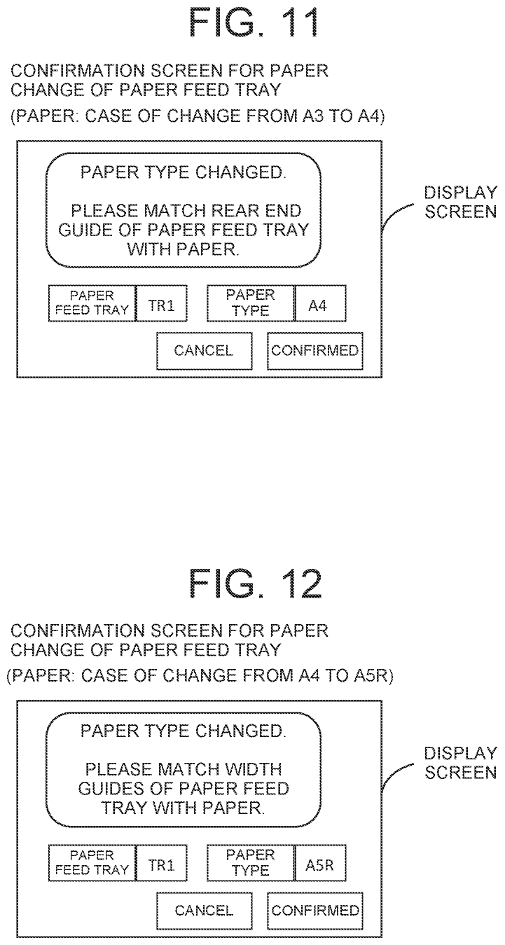

FIG. 4 is a table illustrating the tray confirmation information stored in the memory of the image-forming apparatus according to an embodiment.
FIG. 4 illustrates the tray confirmation information (MSG) corresponding to each of the above-described three conditions.
FIGS. 11, 12, and 13 are explanatory diagrams illustrating display screens requesting the confirmation of the paper guides, which is presented on the display 13 when the paper stored in the paper feed tray is changed according to an embodiment.
FIGS. 11, 12, and 13 illustrate the display screens of the tray confirmation information (MSG) corresponding to the three conditions, respectively.

The tray confirmation information MSG1 is the information corresponding to the condition J1 illustrated in FIG. 3 above, and the notification content notifies the user that the rear end guide needs to be adjusted.

For example, as illustrated in the display message example corresponding to the tray confirmation information MSG1 in FIG. 4, the text “Please match the rear end guide of the paper feed tray with the paper.” is set and stored.
When the above-described confirmation information is selected to select the tray confirmation information MSG1, for example, the display screen of the display 13 presents the confirmation screen illustrated in FIG. 11 including the text of the above display message example.
FIG. 11 illustrates the confirmation screen when the paper is changed from A3 to A4, displaying, in addition to the message that “the rear end guide” needs to be adjusted, the information (TR1) indicating the position of the paper feed tray to be confirmed and the paper type (A4) after the change.

The tray confirmation information MSG2 is the information corresponding to the condition J2 illustrated in FIG. 3 above, and the notification content notifies the user that the width guides need to be adjusted.

As a display message example corresponding to the tray confirmation information MSG2, the text “Please match the width guides of the paper feed tray with the paper.” is set and stored.
When the above-described confirmation information is selected to select the tray confirmation information MSG2, for example, the display screen of the display 13 presents the confirmation screen illustrated in FIG. 12 including the text of the above display message example.
FIG. 12 illustrates the confirmation screen when the paper is changed from A4 to A5R, displaying, in addition to the message that “the width guides” need to be adjusted, the information (TR1) indicating the position of the paper feed tray to be confirmed and the paper type (A5R) after the change.

The tray confirmation information MSG3 is the information corresponding to the condition J3 illustrated in FIG. 3 above, and the notification content notifies the user that the rear end guide and the width guides need to be adjusted.

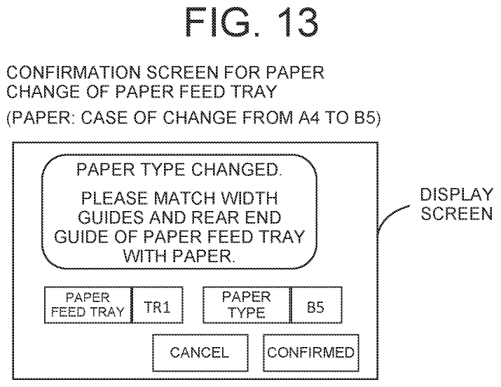

As a display message example corresponding to the tray confirmation information MSG3, the text “Please match the rear end guide and the width guides of the paper feed tray with the paper.” is set and stored.
When the above-described confirmation information is selected to select the tray confirmation information MSG3, for example, the display screen of the display 13 presents the confirmation screen illustrated in FIG. 13 including the text of the above display message example.
FIG. 13 illustrates the confirmation screen when the paper is changed from A4 to B5, displaying, in addition to the message that “the width guides and the rear end guide” need to be adjusted, the information (TR1) indicating the position of the paper feed tray to be confirmed and the paper type (B5) after the change.

The memory 30 is a part that stores information and programs needed to execute each function of the image-forming apparatus according to the present disclosure, and a semiconductor storage device such as a ROM, a RAM, or a flash memory, a storage device such as an HDD or an SSD, and other storage media are used.

The memory 30 stores, for example, the standard paper information 31, the confirmation information selection condition 32, tray confirmation information 33, the input paper type information 34, input tray position information 35, the current paper size information 36, the previous paper size information 37, tray paper information 38, a confirmation selection flag 39, etc.

The standard paper information 31 is information including the type of standard paper and its size (width and length) as described above and is preferably previously stored in the memory 30.

Alternatively, when the paper type is input, a connection may be established with an external database or a server for acquisition from the database, or the like, each time.
In the standard paper information 31 illustrated in FIG. 2, some of what is called A-series and B-series standard paper are illustrated, but information on other standard paper may also be stored.
When there is non-standard paper that is often used by the user of the image-forming apparatus in ordinary circumstances, the information (type, width, and length) of the non-standard paper may be input and stored in the memory 30.

The confirmation information selection condition 32 is the information associating the conditions of the length and the width of the stored paper with the tray confirmation information, and the like, as illustrated in FIG. 3 above and is previously set and stored in the memory 30 by the person in charge of the management of the image-forming apparatus or the user.

The confirmation information selection condition 32 in FIG. 3 describes the conditions (J1, J2, and J3) in a case where the current paper size (width and length) after the paper change is smaller than the previous paper size (width and length) before paper change by the comparison between the current paper size after the paper change and the previous paper size before the paper change.

Primarily, in a case where the stored paper is changed, it is considered that there is a high possibility that the user fails to adjust the paper guide when large-sized paper is changed to small-sized paper, and therefore the conditions in FIG. 3 are the conditions that are set when a large size is changed to a small size.

The confirmation information selection conditions 32 are not limited to these conditions, and other conditions may be set and stored. For example, when small-sized paper is changed to large-sized paper, there is also a possibility of the failure to adjust the paper guide in some orientation of the stored paper, and there may be a case where the paper guide is moved too much that the paper guide is left at a position where the paper guide is not in contact with the paper.

Thus, conditions may be additionally stored to display the tray confirmation information to confirm the states of the rear end guide and the width guides when for example the length side condition is LA>LB and the width side condition is WA>WB.

The tray confirmation information 33 is information in which the content to be notified to the user is previously set as illustrated in FIG. 4 above.

According to the above embodiment, as there are only two types of paper guides, there are three notification contents illustrated in FIG. 4; however, when there are guide members to be in contact with the paper as paper guides other than the rear end guide and the width guides, the information of the notification contents including these guide members may be previously set and stored.

The input paper type information 34 is information on the type of stored paper that is input by the user.

For example, in a case where the paper to be stored in the paper feed tray is changed to “A4 paper”, when the user inputs A4 as the type of stored paper, “A4” is stored in the input paper type information 34.

The input tray position information 35 is information that is input by the user and that specifies the position of the paper feed tray, which is the storage location of the paper.

When the image-forming apparatus includes one paper feed tray, there is no need to input the position of the paper feed tray.
However, when the image-forming apparatus includes a plurality of paper feed trays, the user needs to input the information indicating the position of the paper feed tray, for example, to identify the paper feed tray whose paper was changed by the user.
For example, in a case where there are three paper feed trays and the position of the paper feed tray whose paper was changed by the user is TR1, when the user inputs TR1 as the position of the paper feed tray, “TR1” is stored in the input tray position information 35.

When the image-forming apparatus has the function to detect that the paper feed tray is attached or detached or that the paper feed tray is opened or closed when the user changes the paper, the user does not need to input the position of the paper feed tray, and the opening or closing of the paper feed tray may be automatically detected and the position of the detected paper feed tray may be stored in the input tray position information 35.

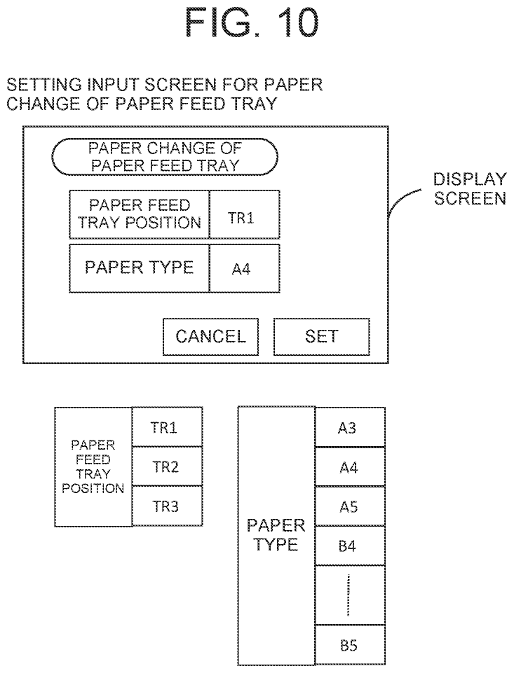

FIG. 10 is an explanatory diagram illustrating a setting input screen when the paper stored in the paper feed tray is changed according to an embodiment.

When the paper stored in the paper feed tray was changed, the user performs a predetermined input operation to display the setting input screen illustrated in FIG. 10, and selects and inputs the position of the paper feed tray whose stored paper was changed and the paper type after the change.
Although the user may directly input information on the position of the paper feed tray and the paper type, the information on the paper feed tray positions and the information on the multiple paper types may be previously stored as illustrated in FIG. 10, the setting input screen in FIG. 10 may be displayed, and the desired paper feed tray position and paper type may be selected from the previously stored paper feed tray positions and paper types.

The setting input screen in FIG. 10 presents the state where TR1 is selected as the paper feed tray position and A4 is selected as the paper type. After the paper feed tray position and the paper type are selected and input, for example, the user selects and inputs a “set” display area to confirm the selection input, and the selected and input information is stored in the input paper type information 34 and the input tray position information 35 described above.

The current paper size information 36 is information including the paper type currently stored in the paper feed tray and the width WA and the length LA associated with the paper type.

For example, when “A4” is stored in the input paper type information 34 by the selection input on the setting input screen in FIG. 10, the paper size acquirer 22 acquires the width WA and the length LA associated with “A4” and stores the width WA and the length LA in the current paper size information 36.

The previous paper size information 37 is information about the paper stored in the paper feed tray before the paper stored in the paper feed tray is changed and is information including the paper type stored in the paper feed tray and the width WB and the length LB associated with the paper type.

In principle, when the paper guide is confirmed after the paper stored in the paper feed tray was changed or when it is confirmed that the paper guide has been adjusted, the previous paper size information 37 is overwritten to store the current paper size information 36.

The tray paper information 38 is information indicating, for each paper feed tray included in the image-forming apparatus, the current state of the paper stored in the paper feed tray.

FIG. 5 is a table illustrating the tray paper information 38 stored in the memory of the image-forming apparatus according to an embodiment.
In the tray paper information 38 illustrated in FIG. 5, for each input tray position, the current paper size information 36, the previous paper size information 37, and the confirmation selection flag 39 are stored in association with each other.

For example, in the tray paper information 38 in FIG. 5, it is understood from the current paper size information 36 that the paper feed tray with the input tray position TR1 currently stores the paper having the paper type “A4” and, when it is assumed that the storage orientation of the A4 paper is the orientation illustrated in FIG. 6C, the width WA of the paper is A4(L) and the length LA is A4(W). The acquired actual dimension values of the A4 paper are stored as A4(L) and A4(W).

It is understood from the previous paper size information 37 that the type of paper stored before the change in the paper feed tray with the input tray position TR1 is “A3” and, when it is assumed that the storage orientation of the A3 paper is the orientation illustrated in FIG. 6B, the width WB of the paper is A3(W) and the length LB is A3(L). The actual dimension values of the A3 paper are stored as A3(W) and A3(L).

When the current paper size information 36 and the previous paper size information 37 are stored for the paper feed tray with the input tray position TR1, the stored paper is changed from A3 to A4 and LA<LB and WA=WB are satisfied according to the confirmation information selection condition 32 described above, and therefore the confirmation selection flag 39 is set to 1.

That is, the confirmation selection flag 39 is set to 1, which means that the tray confirmation information MSG1 is selected as the information to be notified to the user for the paper feed tray with the input tray position TR1.
The confirmation selection flag 39 is the information used exclusively in the program described below and therefore does not need to be stored in the tray paper information 38.

Similarly, in the tray paper information 38 in FIG. 5, for the paper feed tray with the input tray position TR2, based on the current paper size information 36 and the previous paper size information 37, the stored paper is changed from A4 to A5R and LA=LB and WA<WB are satisfied according to the above-described confirmation information selection condition 32, and therefore the confirmation selection flag 39 is set to 2. That is, the confirmation selection flag 39 is set to 2, which means that the tray confirmation information MSG2 is selected as the information to be notified to the user for the paper feed tray with the input tray position TR2.

Similarly, in the tray paper information 38 in FIG. 5, for the paper feed tray with the input tray position TR3, based on the current paper size information 36 and the previous paper size information 37, the stored paper is changed from A4 to B5 and LA<LB and WA<WB are satisfied according to the above-described confirmation information selection condition 32, and therefore the confirmation selection flag 39 is set to 3.

That is, the confirmation selection flag 39 is set to 3, which means that the tray confirmation information MSG3 is selected as the information to be notified to the user for the paper feed tray with the input tray position TR3.

As already illustrated in FIG. 3, the confirmation selection flag 39 is information used to select the tray confirmation information and is used in a program for a confirmation request process of the paper guide.

In FIG. 3, different numeric values are set for the three conditions, respectively.
When there are four or more conditions, different numeric numbers are further set for the conditions, respectively.

Embodiment of Improper Adjustment of Paper Guide

According to the present disclosure, as described above, when the type of paper stored in the paper feed tray is changed and there is a possibility of improper adjustment of the paper guide of the paper feed tray, the user is notified of a message (tray confirmation information) to confirm the state of the paper guide.
Some embodiments in the states of improper adjustment of the paper guide will be described below.

First Embodiment of Improper Adjustment

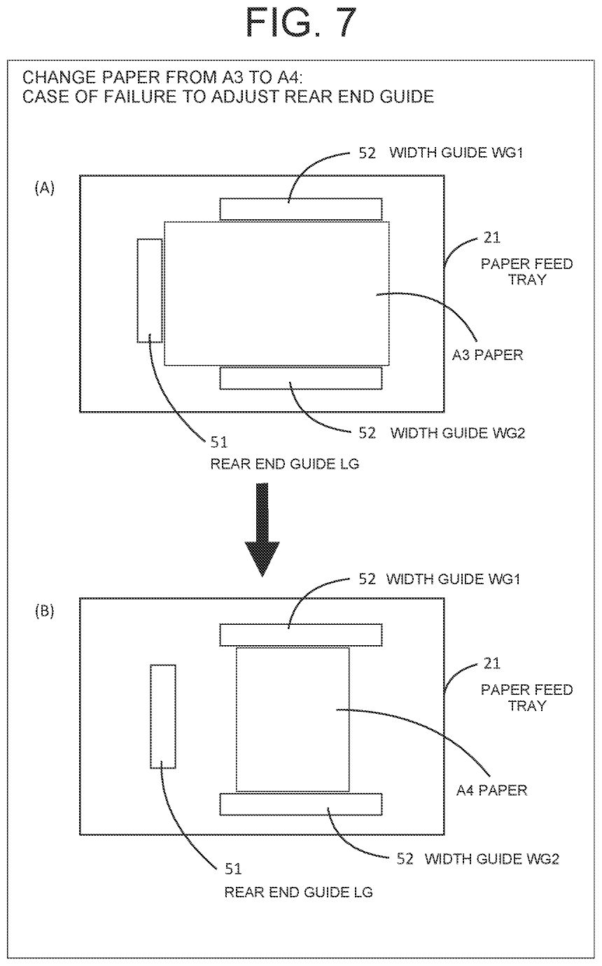

FIG. 7 is an explanatory diagram illustrating the state where the paper guide of the paper feed tray has not been adjusted (improper adjustment of the rear end guide) according to an embodiment.
FIG. 7 illustrates improper adjustment of the rear end guide that may occur when the paper is changed from A3 to A4.

In FIG. 7(A), first, when A3 paper is stored in the paper feed tray 21, the A3 paper is placed such that the long sides of the A3 paper are parallel to the horizontal direction of the paper surface.

At this point, the user moves the rear end guide (LG) 51 so as to come into contact with the short side of the A3 paper on the left end and moves the two width guides 52 (WG1 and WG2) so as to come into contact with the long sides of the A3 paper on the upper and lower ends.
In this state, the A3 paper is taken out through the discharge port in a proper posture, which is unlikely to cause a paper feed jam.

Next, it is assumed that, when the paper in the paper feed tray 21 is changed to A4 paper, the user stores the A4 paper such that the short sides thereof are parallel to the horizontal direction of the paper surface, as illustrated in FIG. 7(B).

Specifically, it is assumed that the A4 paper is stored in portrait orientation such that the long side of the A4 paper comes in contact with the rear end guide 51 and the short side of the A4 paper comes into contact with the width guide 52. In this case, the long side (L) of the A4 paper corresponds to the width (WA) of the paper feed tray 21, and the short side (W) of the A4 paper corresponds to the length (LA) of the paper feed tray 21.
As the A4 paper is smaller than the A3 paper, the A4 paper may be stored without moving the rear end guide 51 and the two width guides 52.

As illustrated in FIG. 7(B), in a case where the A4 paper is stored in portrait orientation, the long side (L) of the A4 paper is the same as the short side (W) of the A3 paper, and therefore the short sides of the A4 paper are in proper contact with the two width guides 52, and the width guides 52 do not need to be moved.

Conversely, in a case where the A4 paper is stored in portrait orientation, the short side (W) of the A4 paper is shorter than the long side (L) of the A3 paper, and therefore when the rear end guide 51 is not moved, there is a distance between the left long side of the A4 paper and the rear end guide 51, and the left long side of the A4 paper is not in contact with the rear end guide 51.

When the user fails to move the rear end guide 51 after storing multiple pieces of A4 paper in portrait orientation, there is a possibility that the multiple pieces of A4 paper are misaligned in the horizontal direction, and when the A4 paper is taken out, the A4 paper may be taken out improperly, which may cause a paper feed jam.

Therefore, as illustrated in FIG. 7(B), as there is a possibility of improper adjustment of the rear end guide 51, the user is notified of the message (the tray confirmation information MSG1) to confirm the state of the rear end guide 51.

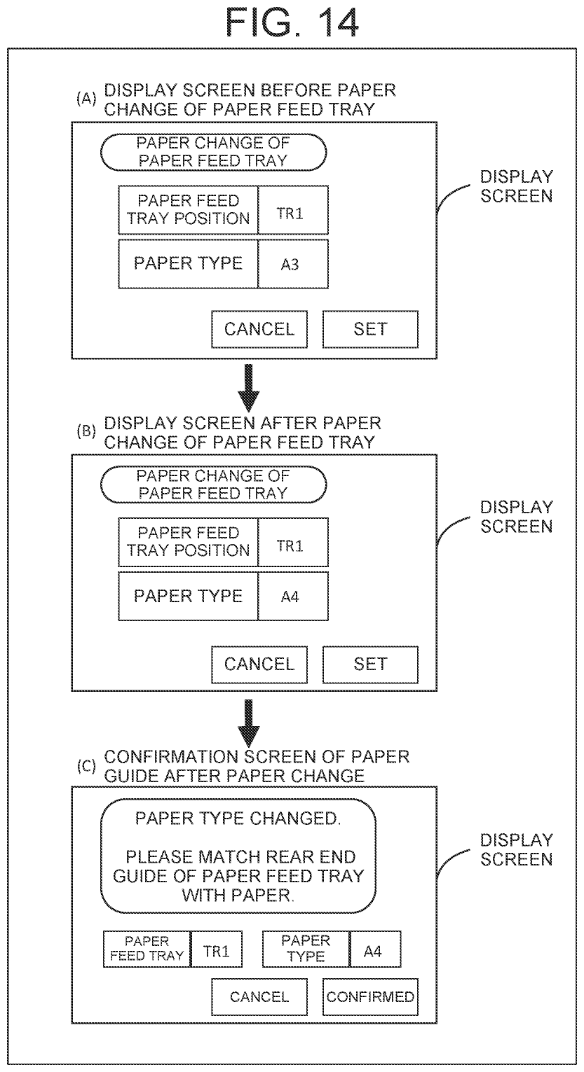

FIG. 14 is an explanatory diagram illustrating the setting input and the display screen when the paper in the paper feed tray is changed according to the first embodiment.

FIG. 14(A) illustrates the setting input screen before paper change in the paper feed tray position “TR1”.
For example, in FIG. 7, when the setting input screen is displayed immediately after the A4 paper after the change is stored in the paper feed tray 21, the setting input screen illustrated in FIG. 14(A) is displayed as no information about the A4 paper after the change has been input yet.
That is, the setting input screen displays the information on the stored paper before the change.
It is assumed that the setting input screen in FIG. 14(A) displays “TR1” as the paper feed tray position and “A3” as the paper type.

Then, the user inputs the information on the A4 paper after the change stored in the paper feed tray position “TR1”. Specifically, the “paper type” of the A4 paper after the change is selected and input.

FIG. 14(B) illustrates the display screen after the information on the A4 paper after the change is input on the setting input screen.
Here, the user selects and inputs “A4” in a selection field on the right of “paper type” on the setting input screen.

When the paper feed tray position where the paper was changed is not displayed in a selection field on the right of the paper feed tray position on the setting input screen in FIG. 14(A), the user may select and input the paper feed tray position “TR1” after the change in the selection field on the right of “paper feed tray position” on the setting input screen.

Then, when the user recognizes that the information on the A4 paper after the change input by the user is correct in the state of the setting input screen in FIG. 14(B), the “set” display area of the setting input screen is selected and input.

Thus, the input of “paper type” of the stored paper after the change is confirmed.

The confirmation of the input of “paper type” is followed by, in this order, the process to acquire the size of the stored paper after the change by the paper size acquirer 22 described above, the process to determine a change in the paper size before and after the change by the size change determiner 23, the process to select the tray confirmation information by the confirmation information selector 24, and the process (for example, display) to notify the tray confirmation information by the confirmation information notifier 25.

When the stored paper is changed from A3 to A4 as illustrated in FIG. 7, there is a possibility of improper adjustment of the rear end guide 51 as illustrated in FIG. 7(B), and therefore MSG1 is selected as the tray confirmation information.

FIG. 14(C) illustrates the confirmation screen of the paper guide after the paper change that is displayed on the display 13 after the above series of processes are performed.
In FIG. 14(C), the confirmation message “Paper type changed. Please match the rear end guide of the paper feed tray with the paper” is displayed.
The user may see the confirmation screen so as to know that, as the paper type of the stored paper in the paper feed tray position “TR1” was changed to “A4”, there is a need to confirm the position of the rear end guide in the paper feed tray position “TR1”.

When the user has already adjusted the position of the rear end guide so as to be in contact with the A4 paper and when it is certain, for example, the user may select and input a “confirmed” display area on the confirmation screen in FIG. 14(C). This selection input ends the process of confirming the paper feed tray, and then the state is obtained such that the printing process, and the like, of the image-forming apparatus is executable.

When the user actually opens the paper feed tray, confirms the position of the rear end guide in the paper feed tray position “TR1”, adjusts the position of the rear end guide so as to be in contact with the A4 paper, closes the paper feed tray, and then selects and inputs the “confirmed” display area, the process of confirming the paper feed tray also ends, and then the state is obtained such that the printing process, and the like, of the image-forming apparatus is executable.

Alternatively, when the user actually opens the paper feed tray, confirms the position of the rear end guide in the paper feed tray position “TR1”, adjusts the position of the rear end guide so as to be in contact with the A4 paper, and closes the paper feed tray, it may be determined that the process of confirming the paper feed tray ended and the confirmation screen in FIG. 14(C) may be deleted. In this case, too, the state is then obtained such that the printing process, and the like, of the image-forming apparatus is executable.

Second Embodiment of Improper Adjustment

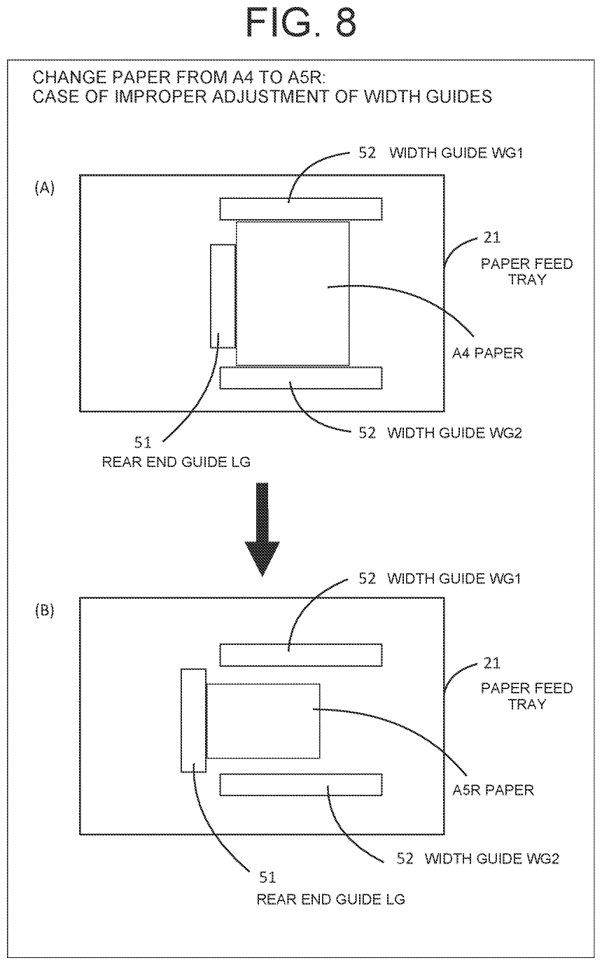

FIG. 8 is an explanatory diagram illustrating the state where the paper guides in the paper feed tray have not been adjusted (improper adjustment of the width guides) according to an embodiment.
FIG. 8 illustrates the improper adjustment of the width guides that may occur when the paper is changed from A4 to A5R.

In FIG. 8(A), first, it is assumed that, when the A4 paper is stored in the paper feed tray 21, the A4 paper is placed such that the short sides of the A4 paper are parallel to the horizontal direction of the paper surface. At this point, the user moves the rear end guide (LG) 51 so as to be in contact with the long side of the A4 paper on the left end and moves the two width guides 52 (WG1 and WG2) so as to be in contact with the short sides of the A4 paper on the upper and lower ends.

In this state, the A4 paper is taken out through the discharge port in a proper posture, which is unlikely to cause a paper feed jam.

Next, it is assumed that, when the paper in the paper feed tray 21 is changed to A5R paper, the user stores the A5R paper such that the long sides of the A5R paper are parallel to the horizontal direction of the paper surface, as illustrated in FIG. 8(B).

Specifically, it is assumed that the A5R paper is stored in landscape orientation such that the short side of the A5R paper comes into contact with the rear end guide 51 and the long side of the A5R paper comes into contact with the width guide 52. In this case, the short side (W) of the A5R paper corresponds to the width (WA) of the paper feed tray 21, and the long side (L) of the A5R paper corresponds to the length (LA) of the paper feed tray 21.
As the A5R paper is smaller than the A4 paper, the A5R paper may be stored without moving the rear end guide 51 and the two width guides 52.

As illustrated in FIG. 8(B), in a case where the A5R paper is stored in landscape orientation, the long side (L) of the A5R paper is the same as the short side (W) of the A4 paper, and therefore the left short side of the A5R paper may be placed so as to be in proper contact with the rear end guide 51.

Conversely, in a case where the A5R paper is stored in landscape orientation, the short side (W) of the A5R paper is shorter than the long side L of the A4 paper, and therefore when the width guides 52 are not moved, there is a distance between the long side of the A5R paper and the two width guides 52, and the long sides of the A5R paper on the upper end and the lower end are not in contact with the width guides 52.

When the user fails to move the width guides 52 after storing multiple pieces of A5R paper in landscape orientation, there is a possibility that the multiple pieces of A5R paper are misaligned in the vertical direction, and when the A5R paper is taken out, the A5R paper may be taken out improperly, which may cause a paper feed jam.

Therefore, as illustrated in FIG. 8(B), as there is a possibility of improper adjustment of the width guides 52, the user is notified of the message (the tray confirmation information MSG2) to confirm the states of the width guides 52.

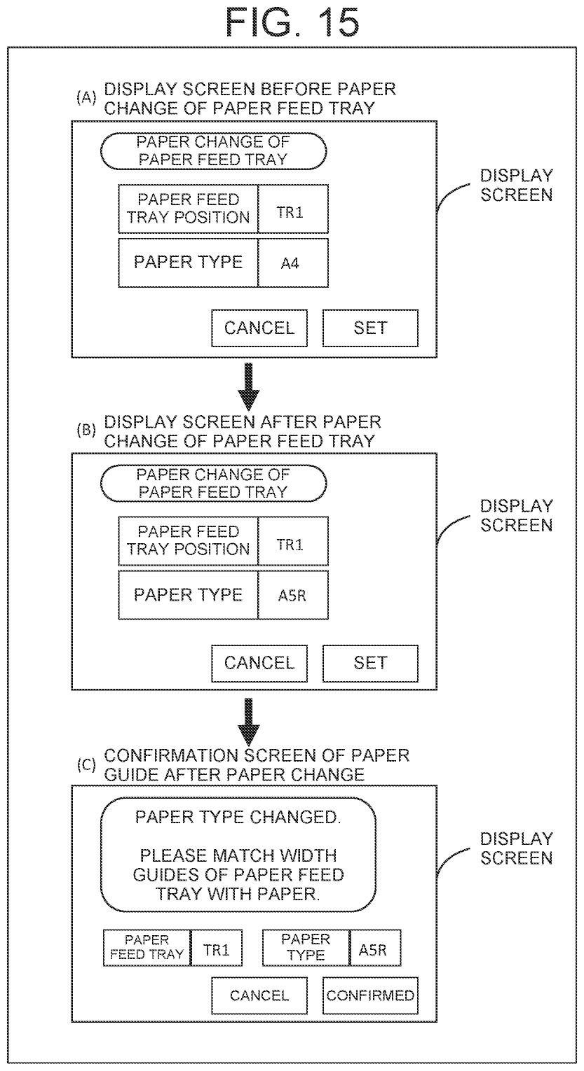

FIG. 15 is an explanatory diagram illustrating the setting input and the display screen when the paper in the paper feed tray is changed according to the second embodiment.

FIG. 15(A) illustrates the setting input screen before paper change in the paper feed tray position “TR1”.
For example, in FIG. 8, when the setting input screen is displayed immediately after the A5R paper after the change is stored in the paper feed tray 21, the setting input screen illustrated in FIG. 15(A) is displayed as no information about the A5R paper after the change has been input yet.
That is, the setting input screen displays the information on the stored paper before the change.
It is assumed that the setting input screen in FIG. 15(A) displays “TR1” as the paper feed tray position and “A4” as the paper type.

Then, the user inputs the information on the A5R paper after the change stored in the paper feed tray position “TR1”. Specifically, “paper type” of the A5R paper after the change is selected and input.

FIG. 15(B) illustrates the display screen after the information on the A5R paper after the change is input on the setting input screen.
Here, the user selects and inputs “A5R” in a selection field on the right of “paper type” on the setting input screen.

When the paper feed tray position where the paper was changed is not displayed in a selection field on the right of the paper feed tray position on the setting input screen in FIG. 15(A), the user may select and input the paper feed tray position “TR1” after the change in a selection field on the right of “paper feed tray position” on the setting input screen.

Then, when the user recognizes that the information on the A5R paper after the change input by the user is correct in the state of the setting input screen in FIG. 15(B), the “set” display area of the setting input screen is selected and input.

Thus, the input of “paper type” of the stored paper after the change is confirmed.

The confirmation of the input of “paper type” is followed by, in this order, the process to acquire the size of the stored paper after the change by the paper size acquirer 22 described above, the process to determine a change in the paper size before and after the change by the size change determiner 23, the process to select the tray confirmation information by the confirmation information selector 24, and the process (for example, display) to notify the tray confirmation information by the confirmation information notifier 25.

When the stored paper is changed from A4 to A5R as illustrated in FIG. 8, there is a possibility of improper adjustment of the width guides 52 as illustrated in FIG. 8(B), and therefore MSG2 is selected as the tray confirmation information.

FIG. 15(C) illustrates the confirmation screen of the paper guide after the paper change that is displayed on the display 13 after the above series of processes are performed.
In FIG. 15(C), the confirmation message “Paper type changed. Please match the width guides of the paper feed tray with the paper” is displayed.
The user may see the confirmation screen so as to know that, as the paper type of the stored paper in the paper feed tray position “TR1” was changed to “A5R”, there is a need to confirm the positions of the width guides in the paper feed tray position “TR1”.

When the user has already adjusted the positions of the width guides so as to be in contact with the A5R paper and when it is certain, for example, the user may select and input a “confirmed” display area on the confirmation screen in FIG. 15(C). This selection input ends the process of confirming the paper feed tray, and then the state is obtained such that the printing process, and the like, of the image-forming apparatus is executable.

When the user actually opens the paper feed tray, confirms the positions of the width guides in the paper feed tray position “TR1”, adjusts the positions of the width guides so as to be in contact with the A5R paper, closes the paper feed tray, and then selects and inputs the “confirmed” display area, the process of confirming the paper feed tray also ends, and then the state is obtained such that the printing process, and the like, of the image-forming apparatus is executable.

Alternatively, when the user actually opens the paper feed tray, confirms the positions of the width guides in the paper feed tray position “TR1”, adjusts the positions of the width guides so as to be in contact with the A5R paper, and closes the paper feed tray, it may be determined that the process of confirming the paper feed tray ended and the confirmation screen in FIG. 15(C) may be deleted. In this case, too, the state is then obtained such that the printing process, and the like, of the image-forming apparatus is executable.

Third Embodiment of Improper Adjustment

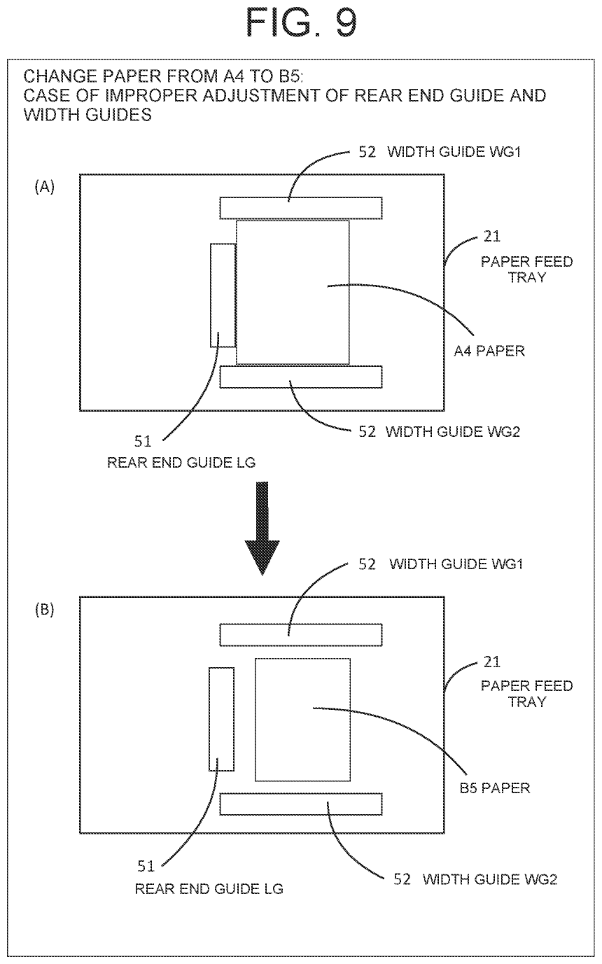

FIG. 9 is an explanatory diagram illustrating the state where the paper guides in the paper feed tray have not been adjusted (improper adjustment of the rear end guide and the width guides) according to an embodiment. FIG. 9 illustrates the improper adjustment of the rear end guide and the width guides that may occur when the paper is changed from A4 to B5. FIG. 9(A) illustrates the state where the A4 paper is stored in the paper feed tray 21 as in FIG. 8(A).

In FIG. 9(A), it is assumed that, when the A4 paper is stored in the paper feed tray 21, the A4 paper is placed such that the short sides of the A4 paper are parallel to the horizontal direction of the paper surface.

At this point, the user moves the rear end guide (LG) 51 so as to be in contact with the long side of the A4 paper on the left end and moves the two width guides 52 (WG1 and WG2) so as to be in contact with the short sides of the A4 paper on the upper and lower ends.
In this state, the A4 paper is taken out through the discharge port in a proper posture, which is unlikely to cause a paper feed jam.

Next, it is assumed that, when the paper in the paper feed tray 21 is changed to B5 paper, the user stores the B5 paper such that the short sides thereof are parallel to the horizontal direction of the paper surface, as illustrated in FIG. 9(B).

Specifically, it is assumed that the B5 paper is stored in portrait orientation such that the long side of the B5 paper comes in contact with the rear end guide 51 and the short side of the B5 paper comes into contact with the width guide 52. In this case, the long side (L) of the B5 paper corresponds to the width (WA) of the paper feed tray 21, and the short side (W) of the B5 paper corresponds to the length (LA) of the paper feed tray 21.
As the B5 paper is smaller than the A4 paper, the B5 paper may be stored without moving the rear end guide 51 and the two width guides 52.

As illustrated in FIG. 9(B), in a case where the B5 paper is stored in portrait orientation, the short side (W) of the B5 paper is smaller than the short side (W) of the A4 paper, and therefore the B5 paper may be placed such that there is a distance between the left long side (L) of the B5 paper and the rear end guide 51.

In a case where the B5 paper is stored in portrait orientation, the long side (L) of the B5 paper is shorter than the long side (L) of the A4 paper, and therefore when the width guides 52 are not moved, there is a distance between the short side of the B5 paper and the two width guides 52, and the short sides of the B5 paper on the upper end and the lower end are not in contact with the width guides 52.

When the user fails to move the rear end guide 51 after storing multiple pieces of B5 paper in portrait orientation, there is a possibility that the multiple pieces of B5 paper are misaligned in the horizontal direction, and when the user fails to move the width guides 52, there is a possibility that the multiple pieces of B5 paper are misaligned in the vertical direction, and when the B5 paper is taken out, the B5 paper may be taken out improperly, which may cause a paper feed jam.

Therefore, as illustrated in FIG. 9(B), as there is a possibility of improper adjustment of the rear end guide 51 and the width guides 52, the user is notified of the message (the tray confirmation information MSG3) to confirm the states of the rear end guide 51 and the width guides 52.

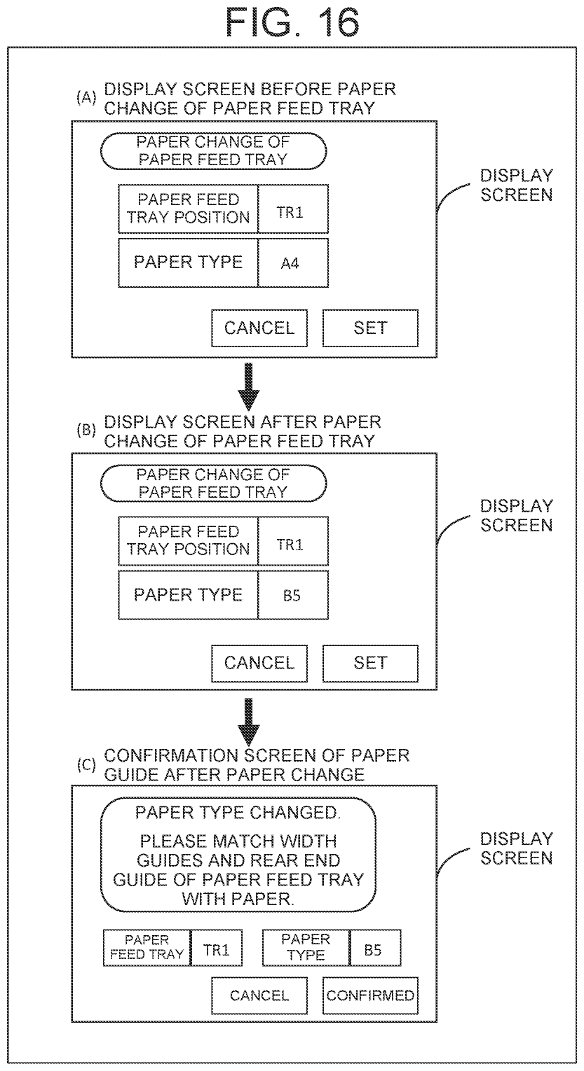

FIG. 16 is an explanatory diagram illustrating the setting input and the display screen when the paper in the paper feed tray is changed according to the third embodiment.

FIG. 16(A) illustrates the setting input screen before paper change in the paper feed tray position “TR1”.
For example, in FIG. 9, when the setting input screen is displayed immediately after the B5 paper after the change is stored in the paper feed tray 21, the setting input screen illustrated in FIG. 16(A) is displayed as no information about the B5 paper after the change has been input yet.
That is, the setting input screen displays the information on the stored paper before the change.
It is assumed that the setting input screen in FIG. 16(A) displays “TR1” as the paper feed tray position and “A4” as the paper type.

Then, the user inputs the information on the B5 paper after the change stored in the paper feed tray position “TR1”. Specifically, “paper type” of the B5 paper after the change is selected and input.

FIG. 16(B) illustrates the display screen after the information on the B5 paper after the change is input on the setting input screen.
Here, the user selects and inputs “B5” in a selection field on the right of “paper type” on the setting input screen.

When the paper feed tray position where the paper was changed is not displayed in a selection field on the right of the paper feed tray position on the setting input screen in FIG. 16(A), the user may select and input the paper feed tray position “TR1” after the change in a selection field on the right of “paper feed tray position” on the setting input screen.

Then, when the user recognizes that the information on the B5 paper after the change input by the user is correct in the state of the setting input screen in FIG. 16(B), the “set” display area of the setting input screen is selected and input.

Thus, the input of “paper type” of the stored paper after the change is confirmed.

The confirmation of the input of “paper type” is followed by, in this order, the process to acquire the size of the stored paper after the change by the paper size acquirer 22 described above, the process to determine a change in the paper size before and after the change by the size change determiner 23, the process to select the tray confirmation information by the confirmation information selector 24, and the process (for example, display) to notify the tray confirmation information by the confirmation information notifier 25.

When the stored paper is changed from A4 to B5 as illustrated in FIG. 9, there is a possibility of improper adjustment of the rear end guide 51 and the width guides 52 as illustrated in FIG. 9(B), and therefore MSG3 is selected as the tray confirmation information.

FIG. 16(C) illustrates the confirmation screen of the paper guide after the paper change that is displayed on the display 13 after the above series of processes are performed.
In FIG. 16(C), the confirmation message “Paper type changed. Please match the width guides and the rear end guide of the paper feed tray with the paper” is displayed.
The user may see the confirmation screen so as to know that, as the paper type of the stored paper in the paper feed tray position “TR1” was changed to “B5”, there is a need to confirm the positions of the width guides and the rear end guide in the paper feed tray position “TR1”.

When the user has already adjusted the positions of the width guides and the rear end guide so as to be in contact with the B5 paper and when it is certain, for example, the user may select and input a “confirmed” display area on the confirmation screen in FIG. 16(C). This selection input ends the process of confirming the paper feed tray, and then the state is obtained such that the printing process, and the like, of the image-forming apparatus is executable.

When the user actually opens the paper feed tray, confirms the positions of the width guides and the rear end guide in the paper feed tray position “TR1”, adjusts the positions of the width guides and the rear end guide so as to be in contact with the B5 paper, closes the paper feed tray, and then selects and inputs the “confirmed” display area, the process of confirming the paper feed tray also ends, and then the state is obtained such that the printing process, and the like, of the image-forming apparatus is executable.

Alternatively, when the user actually opens the paper feed tray, confirms the positions of the width guides and the rear end guide in the paper feed tray position “TR1”, adjusts the positions of the width guides and the rear end guide so as to be in contact with the B5 paper, and closes the paper feed tray, it may be determined that the process of confirming the paper feed tray ended and the confirmation screen in FIG. 16(C) may be deleted. In this case, too, the state is then obtained such that the printing process, and the like, of the image-forming apparatus is executable.

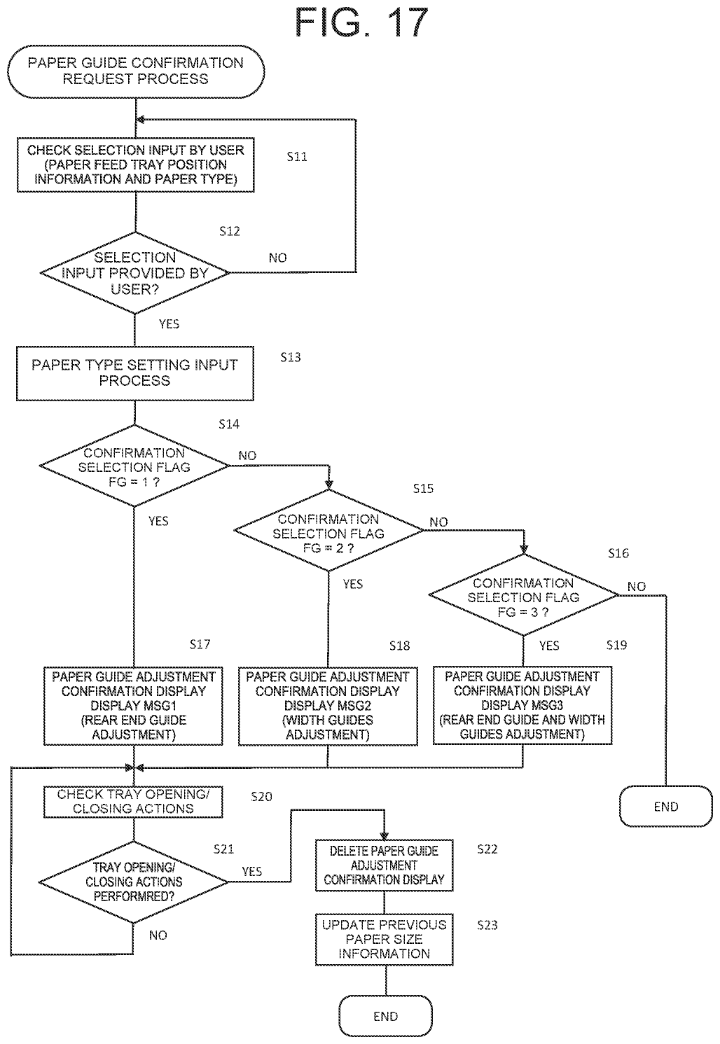

Embodiment of Paper Guide Confirmation Request Process FIG. 17 is a flowchart illustrating a paper guide confirmation request process when the paper stored in the paper feed tray is changed according to an embodiment.

Here, it is assumed that an opening action of the paper feed tray may be automatically detected due to an opening operation of the paper feed tray by the user and a closing action of the paper feed tray may be automatically detected due to a closing operation of the paper feed tray by the user.

At Step S11 of FIG. 17, it is checked whether the position information on the paper feed tray and the paper type information after the change were selected and input by the user.

At Step S12, when the selection input was provided by the user, the process proceeds to Step S13 and otherwise returns to Step S11.

At Step S13, a paper type setting input process is executed. During the paper type setting input process, primarily, by using the input content of the information (paper type and paper feed tray) about the paper after the change, the current paper size information is acquired, and the process (selection determination process) is performed to select the confirmation information on the paper guide.

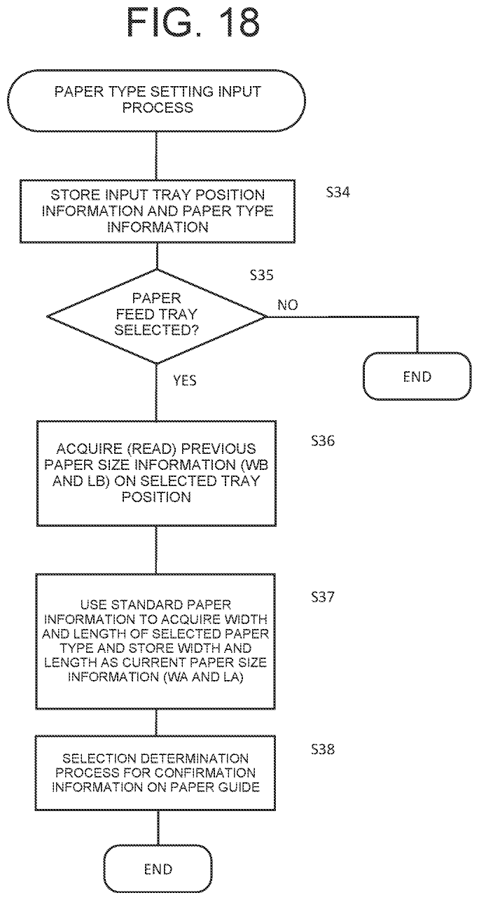

It is assumed that, during the paper type setting input process, the confirmation selection flag FG is set. It is assumed that the confirmation selection flag FG is set to any one of the three types of numeric values illustrated in FIGS. 3 and 5.
FIG. 18 illustrates a detailed flowchart of the paper type setting input process.

At Step S14, when the confirmation selection flag FG is 1, the process proceeds to Step S17 and otherwise proceeds to Step S15.

At Step S15, when the confirmation selection flag FG is 2, the process proceeds to Step S18 and otherwise proceeds to Step S16.
At Step S16, when the confirmation selection flag FG is 3, the process proceeds to Step S19 and otherwise the process may end or return to Step S11.

At Step S17, the confirmation screen corresponding to the tray confirmation information MSG1 illustrated in FIG. 4 is displayed as the display screen to confirm the adjustment of the paper guide (the confirmation screen for a paper change).

For example, as illustrated in FIG. 11, the confirmation screen requesting the confirmation of the adjustment of the rear end guide is displayed.

At Step S18, the confirmation screen corresponding to the tray confirmation information MSG2 illustrated in FIG. 4 is displayed as the display screen to confirm the adjustment of the paper guide (the confirmation screen for a paper change).

For example, as illustrated in FIG. 12, the confirmation screen requesting the confirmation of adjustment of the width guides is displayed.

At Step S19, the confirmation screen corresponding to the tray confirmation information MSG3 illustrated in FIG. 4 is displayed as the display screen to confirm the adjustment of the paper guide (the confirmation screen for a paper change).

For example, as illustrated in FIG. 13, the confirmation screen requesting the confirmation of adjustment of the width guides and the rear end guide is displayed.
After each of Steps S17, S18, and S19, the process proceeds to Step S20.

When the confirmation screen for a paper change is displayed at Steps S17, S18, and S19, the user confirms the display content, then pulls out the paper feed tray of which the paper was changed, and confirms the state of the paper guide of the paper feed tray.

In particular, it is confirmed whether one or both of the width guides and the rear end guide, for which the confirmation screen is displayed, are in contact with the stored paper.

When it is confirmed that the paper guide is not in contact with the stored paper, the user moves the paper guide, which is not in contact, so as to be in contact with the stored paper and closes the paper feed tray to be set back to its original position.

When the user performs this confirmation operation, the opening action and the closing action of the paper feed tray are conducted.
When the opening action and the closing action of the paper feed tray are conducted, it is assumed that the user actually confirmed the paper guide and adjusted the paper guide.

At Step S20, it is checked whether the opening and closing actions of the paper feed tray were conducted.

In addition to or instead of detecting that the opening and closing actions of the paper feed tray were conducted, it may be checked whether an input operation indicating “confirmed” was performed by the user.

At Step S21, when it is detected that the opening and closing actions of the paper feed tray were conducted, the process proceeds to Step S22 and otherwise returns to Step S20.

When the input operation indicating “confirmed” was performed by the user, too, the process proceeds to Step S22.

At Step S22, as the adjustment of the paper guide ended, the display screen to confirm the adjustment of the paper guide (the confirmation screen for a paper change) is deleted.

At Step S23, the previous paper size information 37 is updated.
Here, the content stored in the current paper size information 36 is stored in the previous paper size information 37.

During the above-described process, when the paper in the paper feed tray is changed, the appropriate confirmation screen for a paper change is displayed depending on the type of paper before and after the change, and thus it is possible to ensure that the user confirms and adjusts the paper guide of the paper feed tray in which the paper was changed, and it is possible to reduce the possibility of occurrence of improper adjustment of the paper guide.

FIG. 18 is a flowchart illustrating the selection of the paper feed tray and the setting input process (paper type setting input process) of the type of stored paper according to an embodiment.

The flowchart of the paper type setting input process is the process executed at Step S13 in FIG. 17 described above.

At Step S34 of FIG. 18, the position information on the selected and input paper feed tray and the paper type information after the change are stored in the memory 30.

At Step S35, when the paper feed tray was selected and input, the process proceeds to Step S36 and otherwise the process ends.

The case where the paper feed tray is not selected corresponds to, for example, the case where the manual feed tray is selected, and as there is no need to confirm the paper guides in the paper feed tray, the process ends.

At Step S36, the previous paper size information (WB and LB) 37 of the selected and input tray position is acquired (read) from the memory 30. At Step S37, the standard paper information is used to acquire the width and length of the selected and input paper type and store the width and length as the current paper size information (WA and LA) 36.

At Step S38, the selection determination process for the confirmation information on the paper guide is executed.

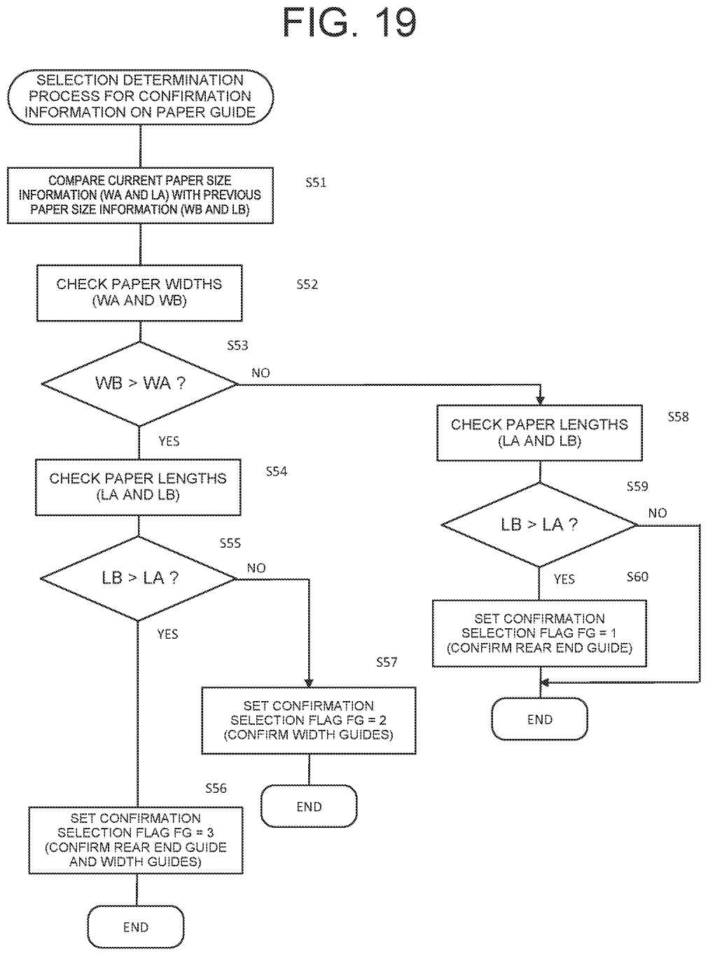

Here, primarily, the current paper size information (WA and LA) 36 is compared with the previous paper size information (WB and LB) 37, and, from the comparison result, the process is performed to select the confirmation information (tray confirmation information) on the paper guide.
During this process, the confirmation selection flag FG corresponding to the tray confirmation information is set.
FIG. 19 illustrates a detailed flowchart of the selection determination process for the confirmation information on the paper guide.

FIG. 19 is a flowchart illustrating the selection determination process for the confirmation information on the paper guide according to an embodiment.

The flowchart of the selection determination process is the process executed at Step S38 in FIG. 18 described above.

At Step S51 of FIG. 19, the current paper size information (WA and LA) 36 is compared with the previous paper size information (WB and LB) 37.

At Step S52, first, the paper widths (WA and WB) before and after the change are checked.
At Step S53, when WB>WA, i.e., the width WA of the paper after the change is smaller than the width WB of the paper before the change, the process proceeds to Step S54 and otherwise proceeds to Step S58.

At Step S54, the lengths (LA and LB) of the paper before and after the change are checked.

At Step S55, when LB>LA, i.e., the length LA of the paper after the change is smaller than the length LB of the paper before the change, the process proceeds to Step S56 and otherwise proceeds to Step S57.

At Step S58, the lengths (LA and LB) of the paper before and after the change are checked as at Step S54.

At Step S59, when LB>LA, i.e., the length LA of the paper after the change is smaller than the length LB of the paper before the change, the process proceeds to Step S60 and otherwise the process ends.

At Step S56, the confirmation selection flag FG is set to 3, and the process ends.

When the process proceeds to Step S56, as WB>WA and LB>LA, the condition J3 of the confirmation information selection condition 32 in FIG. 3 is satisfied.
In the case of the condition J3, both the rear end guide and the width guides need to be adjusted, and therefore the confirmation selection flag FG is set to 3 to request the user to confirm both the rear end guide and the width guides.

At Step S57, the confirmation selection flag FG is set to 2, and the process ends.

When the process proceeds to Step S57, as WB>WA and LB 5 LA, the condition J2 of the confirmation information selection condition 32 in FIG. 3 is satisfied.
In the case of the condition J2, the width guides need to be adjusted, and therefore the confirmation selection flag FG is set to 2 to request the user to confirm the width guides.

At Step S60, the confirmation selection flag FG is set to 1, and the process ends.

When the process proceeds to Step S60, as WB<WA and LB>LA, the condition J1 of the confirmation information selection condition 32 in FIG. 3 is satisfied.
In the case of the condition J1, the rear end guide needs to be adjusted, and therefore the confirmation selection flag FG is set to 1 to request the user to confirm the rear end guide.

During the above process, when the paper is changed, the confirmation selection flag FG is set to select the confirmation information for the paper guide.

### Summary of Embodiment

### First Embodiment: Acquisition of Size of Stored Paper

According to the above embodiment of the present disclosure, the size of the paper stored in the paper feed tray is used to determine whether the stored paper was changed, but the paper feed tray of the image-forming apparatus according to the present disclosure does not have the function to automatically detect the size of the stored paper.

To acquire the size of the paper stored in the paper feed tray, the user may directly input the size of the stored paper. In particular, when the stored paper is not standard paper, there is a need to directly input the size of the stored paper.

Alternatively, as described above, when the stored paper is standard paper, the size of the standard paper is defined depending on the type of standard paper, and therefore the correspondence relation (standard paper information) between the type and the size of standard paper may be previously stored, and when the user inputs the type of stored paper, the size of the stored paper may be acquired based on the input type.

When the image-forming apparatus has a communication function, a connection may be established with a server that stores the correspondence relation (standard paper information) between the type and the size of standard paper, the type of stored paper input by the user may be transmitted to the server, and the size of the stored paper corresponding to the type of stored paper may be acquired from the server.

### Second Embodiment: Confirmation Information Selection Condition

In FIG. 3 described above, the conditions in a case where, among the paper stored in the paper feed tray, the size of the paper after the change is smaller than the size of the paper before the change are illustrated as the confirmation information selection conditions.
It is considered that there is a high possibility of occurrence of improper adjustment of the paper guide when the size of the paper after the change is smaller than the size of the paper before the change, but that is not always the case.

Even in a case where the size of the paper after the change is larger than the size of the paper before the change, there is a need to move the paper guide when the paper is changed, and therefore there may be the failure to adjust the paper guide after the paper guide is moved, and there is a possibility of occurrence of improper adjustment of the paper guide. Therefore, as the confirmation information selection condition, it is preferable to also previously store the condition in a case where the size of the paper after the change is larger than the size of the paper before the change.

For example, it is also possible to set and store the condition indicating the selection of the tray confirmation information MSG1, which requests the confirmation of the position of the rear end guide when the current paper length LA is larger than the previous paper length LB (LA>LB).

### Third Embodiment: Method for Notifying Tray Confirmation Information

In the description according to the above-described embodiment of the present disclosure, three display messages are illustrated as the tray confirmation information MSG and, as illustrated in FIG. 11, the display message is presented to request the user to confirm the position of the paper guide.
However, the method for notifying the user of the tray confirmation information is not limited to displaying the character information of the confirmation content.

In addition to or instead of character information, the confirmation content may be displayed as a graphic or image.

For example, instead of displaying the rear end guide and the width guides to be confirmed with character information, the shape of the paper feed tray may be displayed as a graphic, the rear end guide and the width guides may be displayed as graphics at the approximate positions of the rear end guide and the width guides provided in the paper feed tray, and the graphic portion of the paper guide to be confirmed may be blinked.

The content of the tray confirmation information may also be notified by voice output from a speaker.

Furthermore, the content of the tray confirmation information may be transmitted to a mobile terminal of the person in charge of management of the image-forming apparatus or the user.

What is claimed is:

1. An image-forming apparatus comprising:
a paper storage that stores paper on which an image is formed;
a paper guide that is movably provided in the paper storage and restricts a position of the stored paper;
a paper size acquirer that acquires a size of the paper stored in the paper storage;
a size change determiner that determines, by using the acquired size of the paper, whether the paper stored in the paper storage was changed;
a confirmation information selector that, when it is determined that the paper stored in the paper storage was changed, selects confirmation information requesting confirmation of a position of the paper guide in the paper storage in accordance with a difference in size between paper before and after the change; and
a confirmation information notifier that notifies the selected confirmation information.

2. The image-forming apparatus according to claim 1, further comprising an operation acceptor with which a type of the stored paper is input, wherein
the paper size acquirer acquires a size of paper previously associated with the type based on the input type of the paper.

3. The image-forming apparatus according to claim 1, further comprising a memory that stores previous paper size information that is a size of first paper stored in the paper storage before the paper was changed, wherein
the paper size acquirer acquires current paper size information that is a size of second paper after the paper stored in the paper storage was changed,
the size change determiner compares the previous paper size information with the current paper size information to determine whether the size of the second paper is different from the size of the first paper, and
when it is determined that the size of the second paper is different from the size of the first paper, the confirmation information selector selects the confirmation information.

4. The image-forming apparatus according to claim 1, wherein
the size of the paper acquired by the paper size acquirer includes
a length of the paper in a direction parallel to a conveyance direction to take out the paper stored in the paper storage, and
a width in a direction perpendicular to the conveyance direction,
the paper guide includes
a rear end guide that comes into contact with one side at a rear end of the stored paper to restrict the position of the stored paper and is movable in the conveyance direction, and
a width guide that comes into contact with one side of the stored paper in the direction perpendicular to the conveyance direction to restrict the position of the stored paper and is movable in the direction perpendicular to the conveyance direction, and
the confirmation information selector selects confirmation information requesting confirmation of one or both of positions of the rear end guide and the width guide based on a difference in the length between paper before and after the change and a difference in the width between paper before and after the change.

5. The image-forming apparatus according to claim 4, wherein when the length of the paper after the change stored in the paper storage is smaller than the length of the paper before the change stored in the paper storage, the confirmation information selector selects confirmation information requesting confirmation of the position of the rear end guide.

6. The image-forming apparatus according to claim 4, wherein when the width of the paper after the change stored in the paper storage is smaller than the width of the paper before the change stored in the paper storage, the confirmation information selector selects confirmation information requesting confirmation of the position of the width guide.

7. The image-forming apparatus according to claim 4, wherein when the length of the paper after the change stored in the paper storage is smaller than the length of the paper before the change stored in the paper storage and the width of the paper after the change stored in the paper storage is smaller than the width of the paper before the change stored in the paper storage, the confirmation information selector selects confirmation information requesting confirmation of the positions of the rear end guide and the width guide.

8. The image-forming apparatus according to claim 1, further comprising a display, wherein
the confirmation information notifier displays the selected confirmation information on the display to notify the user.

9. A paper guide confirmation method for an image-forming apparatus, the paper guide confirmation method comprising:
acquiring, when a type of paper stored in a paper feed tray, which stores paper, is input, a size of paper previously associated with the input type of the paper;
determining, by using the acquired size of the paper, whether the paper stored in the paper feed tray was changed;
selecting, when it is determined that the paper stored in the paper feed tray was changed, confirmation information requesting confirmation of a position of a paper guide movably provided in the paper feed tray in accordance with a difference in size between paper before and after the change; and
notifying the selected confirmation information to a user.
